(19) United States
(12) Patent Application Publication
(10) Pub. No.: US 2010/0238152 A1
(43) Pub. Date: Sep. 23, 2010

(54) PLASMA DISPLAY DEVICE

(75) Inventors: Yoon Chang Choi, Kyungsangbuk-do (KR); Byoung Gun Kim, Kyungsangbuk-do (KR); Dong Soo Lee, Kyungsangbuk-do (KR); Seong Ho Kang, Kyungsangbuk-do (KR); Kyung Ryeol Shim, Kyungsangbuk-do (KR)

Correspondence Address: KED & ASSOCIATES, LLP, P.O. Box 221200, Chantilly, VA, 20153-1200, US

(73) Assignee: LG ELECTRONICS INC., Seoul (KR)

(21) Appl. No.: 12/377,453

(22) PCT Filed: Mar. 6, 2008
(86) PCT No.: PCT/KR2008/001287

§ 371 Date: Jun. 4, 2010

(30) Foreign Application Priority Data
Nov. 9, 2007 (KR) 10-2007-0114278

(51) Int. Cl. G09G 5/00

(52) U.S. Cl. 345/211; 345/60

(57) ABSTRACT

A method of driving a plasma display panel (PDP) and a plasma display device using the same are provided. In the plasma display device, a plurality of scan electrodes formed on the PDP are divided into first and second groups to supply scan signals. When a scan bias voltage is higher in a first subfield in first and second subfields, lowermost voltages of reset signals are higher in the second subfield. According to the plasma display device, when the plurality of scan electrodes are divided into at least two groups to be driven, the lowermost voltages of the reset signals are controlled in accordance with a scan bias voltage so that it is possible to reduce address erroneous discharge in accordance with the loss of wall charges, to prevent the generation of brilliant points, and to improve the picture quality of a displayed image.

### TECHNICAL FIELD

The present invention relates to a plasma display device, and more particularly, to a method of driving a plasma display panel (PDP).

### BACKGROUND ART

A plasma display device includes a panel on which a plurality of discharge cells are formed between a rear surface substrate on which barrier ribs are formed and a front surface substrate that faces the rear surface substrate to selectively discharge the plurality of discharge cells in accordance with input image signals so that vacuum ultraviolet (UV) rays generated by the discharge emit light from phosphors and that an image is displayed.

In order to effectively display an image, the plasma display device commonly includes a driving control unit for processing input image signals to output the processed image signals to a driver for supplying driving signals to a plurality of electrodes included in the panel.

In the case of a large screen plasma display device, time margin for driving a panel is insufficient to drive the panel at high speed.

### DISCLOSURE OF INVENTION

### Technical Solution

A plasma display device according to the present invention includes a plasma display panel (PDP) including a plurality of scan electrodes and sustain electrodes formed on an upper substrate and a plurality of address electrodes formed on a lower substrate and drivers for supplying driving signals to the plurality of electrodes. Reset signals supplied to the scan electrodes in a reset period sequentially comprise a set up period gradually rising to a first voltage, a sustain period sustaining a second voltage, and a set down period gradually falling from the second voltage. A duration of the sustain period varies in accordance with an average picture level (APL) of an image signal. The plurality of scan electrodes are divided into first and second groups. An address period comprises first and second group scan periods for supplying scan signals to the first and second groups, respectively. Scan bias voltages supplied to the first and second groups in at least one period of the first and second group scan periods are different from each other.

### BRIEF DESCRIPTION OF THE DRAWINGS

FIG. 1 is a perspective view illustrating the structure of a plasma display panel (PDP) according to an embodiment of the present invention;

FIG. 2 illustrates arrangement of the electrodes of the PDP according to an embodiment of the present invention;

FIG. 3 is a timing diagram illustrating a method of dividing one frame into a plurality of subfields to time division drive the PDP according to an embodiment of the present invention;

FIG. 4 is a timing diagram illustrating shapes of driving signals for driving the PDP according to an embodiment of the present invention;

FIG. 5 illustrates the structure of a driving device for driving the PDP according to an embodiment of the present invention;

FIGS. 6 to 9 are timing diagrams illustrating a method of dividing the scan electrodes of the PDP into two groups to drive the scan electrodes according to embodiments of the present invention;

FIGS. 10 and 11 are timing diagrams illustrating a method of driving the scan electrodes of the PDP into two groups to drive the scan electrodes according to embodiments of the present invention;

FIGS. 12 to 15 are timing diagrams illustrating a method of driving the scan electrodes of the PDP into bur groups to drive the scan electrodes according to embodiments of the present invention;

FIG. 16 is a timing diagram illustrating reset signal shapes supplied to the scan electrodes according to an embodiment of the present invention;

FIG. 17 is a graph illustrating a change in the number of sustain signals in accordance with the average picture level (APL) of image signals according to an embodiment of the present invention;

FIG. 18 is a timing diagram illustrating driving signal shapes supplied to the scan electrodes in one frame in accordance with a change in the APL;

FIGS. 19 and 20 are timing diagrams illustrating driving signal shapes according to embodiments of the present invention; and

FIG. 21 is a graph illustrating a change in the length of a reset signal sustain period in accordance with the APL of the image signals according to an embodiment of the present invention.

### MODE FOR THE INVENTION

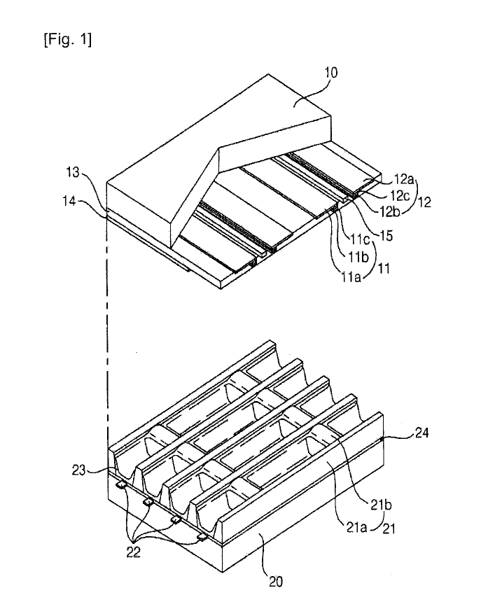

Hereinafter, a plasma display device according to the present invention will be described in detail with reference to the accompanying drawings. FIG. 1 is a perspective view illustrating the structure of a plasma display panel (PDP) according to an embodiment of the present invention.

As illustrated in FIG. 1, the PDP includes a scan electrode 11 and a sustain electrode 12 that are a pair of sustain electrodes formed on an upper substrate 10 and address electrodes 22 formed on a lower substrate 20.

The pair of sustain electrodes 11 and 12 commonly includes transparent electrodes 11a and 12a commonly formed of indium tin oxide (ITO) and bus electrodes 11b and 12b. The bus electrodes 11b and 12b can be formed of a metal such as Ag and Cr, a laminated structure of Cr/Cu/Cr, or a laminated structure of Cr/Al/Cr. The bus electrodes 11b and 12b are formed on the transparent electrodes 11a and 12a to reduce voltage drop caused by the transparent electrodes 11a and 12a having high resistance.

On the other hand, according to an embodiment of the present invention, the pair of sustain electrodes 11 and 12 can be formed of only the bus electrodes 11b and 12b without the transparent electrodes 11a and 12a as well as the transparent electrodes 11a and 12a and the bus electrodes 11b and 12b that are laminated with each other. In the structure where the pair of sustain electrodes 11 and 12 are formed of only the bus electrodes 11b and 12b without the transparent electrodes 11a and 12a, since the transparent electrodes 11a and 12a are not used, the manufacturing cost of the panel can be reduced. The bus electrodes 11b and 12b used for the above-described structure can be formed of various materials such as a photosensitive material other than the above-described materials.

A method of driving the PDP according to the present invention and a plasma display device using the same will be described in detail with reference to the accompanying drawings of the transparent electrodes 11a and 12a and the bus electrodes 11b and 11c of the scan electrode 11 and the sustain electrode 12. FIG. 1 is a perspective view illustrating the structure of a plasma display panel (PDP) according to an embodiment of the present invention.

As illustrated in FIG. 1, the PDP includes a scan electrode 11 and a sustain electrode 12 that are a pair of sustain electrodes formed on an upper substrate 10 and address electrodes 22 formed on a lower substrate 20.

The pair of sustain electrodes 11 and 12 commonly includes transparent electrodes 11a and 12a commonly formed of indium tin oxide (ITO) and bus electrodes 11b and 12b. The bus electrodes 11b and 12b can be formed of a metal such as Ag and Cr, a laminated structure of Cr/Cu/Cr, or a laminated structure of Cr/Al/Cr. The bus electrodes 11b and 12b are formed on the transparent electrodes 11a and 12a to reduce voltage drop caused by the transparent electrodes 11a and 12a having high resistance.

On the other hand, according to an embodiment of the present invention, the pair of sustain electrodes 11 and 12 can be formed of only the bus electrodes 11b and 12b without the transparent electrodes 11a and 12a as well as the transparent electrodes 11a and 12a and the bus electrodes 11b and 12b that are laminated with each other. In the structure where the pair of sustain electrodes 11 and 12 are formed of only the bus electrodes 11b and 12b without the transparent electrodes 11a and 12a, since the transparent electrodes 11a and 12a are not used, the manufacturing cost of the panel can be reduced. The bus electrodes 11b and 12b used for the above-described structure can be formed of various materials such as a photosensitive material other than the above-described materials.

Black matrices (BM) 15 for absorbing external light generated in the outside of the upper substrate 10 to reduce reflection and to shield light and for improving the purity and contrast of the upper substrate 10 are provided between the transparent electrodes 11a and 12a and the bus electrodes 11b and 11c of the scan electrode 11 and the sustain electrode 12.

The BMs 15 according to an embodiment of the present invention formed in the upper substrate 10 can include first BMs 15 formed to overlap barrier ribs 21 and second BMs 11c and 12c formed between the transparent electrodes 11a and 12a and the bus electrodes 11b and 12b. Here, the first BMs 15 and the second BMs 11c and 12c referred to as black layers or black electrode layers can be simultaneously formed to be physically connected to each other or may not be simultaneously formed not to be physically connected to each other.

In addition, when the first BMs 15 and the second BMs 11c and 12c are physically connected to each other, the first BMs 15 and the second BMs 11c and 12c are formed of the same material, however, when the first BMs 15 and the second BMs 11c and 12c are physically separated from each other, the first BMs 15 and the second BMs 11c and 12c can be formed of different materials.

An upper dielectric layer 13 and a protective layer 14 are laminated on the upper substrate 10 where the scan electrode 11 and the sustain electrode 12 are formed to run parallel with each other. Charged particles generated by discharge are accumulated on the upper dielectric layer 13 to protect the pair of sustain electrodes 11 and 12. The protective layer 14 protects the upper dielectric layer 13 against the sputerring of the charged particles generated during gas discharge and improves the emission efficiency of secondary electrons.

In addition, the address electrodes 22 intersect the scan electrode 11 and the sustain electrode 12. In addition, a lower dielectric layer 24 and the barrier ribs 21 are formed on the lower substrate 20 where the address electrodes 22 are formed.

In addition, phosphor layers 23 are formed the surfaces of the lower dielectric layer 24 and the barrier ribs 21. The barrier ribs 21 include vertical barrier ribs 21a and horizontal barrier ribs 21b in a closed type to physically partition off discharge cells and to prevent UV rays and visible rays generated by discharge from leaking to adjacent discharge cells.

According to an embodiment of the present invention, various shaped barrier ribs 21 as well as the barrier ribs 21 illustrated in FIG. 1 can be provided. For example, differential barrier ribs in which the vertical barrier ribs 21a and the horizontal barrier ribs 21b have different heights, channel type barrier ribs in which channels that can be used as exhausting pipes are formed in at least one of the vertical barrier ribs 21a and the horizontal barrier ribs 21b, and hollow type barrier ribs in which hollows are formed in at least one of the vertical barrier ribs 21a and the horizontal barrier ribs 21b.

Here, in the case of the differential barrier ribs, the height of the horizontal barrier ribs 21b is preferably larger than the height of the vertical barrier ribs 21a and, in the case of the channel type barrier ribs or the hollow type barrier ribs, the channels or the hollows are preferably formed in the horizontal barrier ribs 21b.

On the other hand, according to an embodiment of the present invention, it is illustrated and described that R, G, and B discharge cells are arranged on the same line. However, the R, G, and B discharge cells can be differently arranged. For example, the R, G, and B discharge cells can be triangularly arranged, that is, can be arranged in a delta type. In addition, the discharge cells can be polygonal such as square, pentagonal, and hexagonal.

In addition, the phosphor layers 23 emit light by the UV rays generated during the gas discharge to generate one of the red (R), green (G), and blue (B) visible rays. Here, an inert mixed gas such as He+Xe, Ne+Xe, and He+Ne+Xe for discharge is injected into discharge spaces provided between the upper and lower substrates 10 and 20 and the barrier ribs 21.

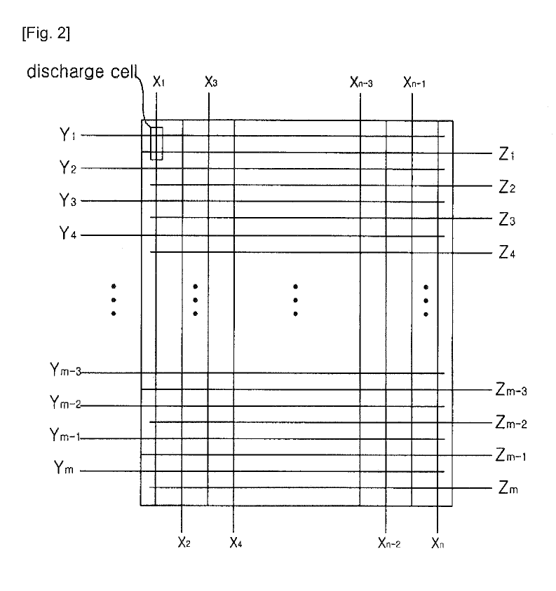

FIG. 2 illustrates arrangement of the electrodes of the PDP according to an embodiment of the present invention. A plurality of discharge cells that constitute the PDP are preferably arranged in a matrix as illustrated in FIG. 2. The plurality of discharge cells are provided in the intersections of scan electrode lines Y1 to Ym, sustain electrode lines Z1 to Zm, and address electrode lines X1 to Xn. The scan electrode lines Y1 to Ym can be sequentially or simultaneously driven and the sustain electrode lines Z1 to Zm can be simultaneously driven. The address electrode lines X1 to Xn can be divided into odd lines and even lines to be driven or can be sequentially driven.

Since the electrode arrangement of the PDP illustrated in FIG. 2 is in accordance with an embodiment of the present invention, the present invention is not limited to the electrode arrangement and the driving method of the PDP illustrated in FIG. 2. For example, a dual scan method in which two scan electrode lines among the scan electrode lines Y1 to Ym are simultaneously scanned can be performed. In addition, the address electrode lines X1 to Xn can be divided up and down or from side to side in the center of the panel to be driven.

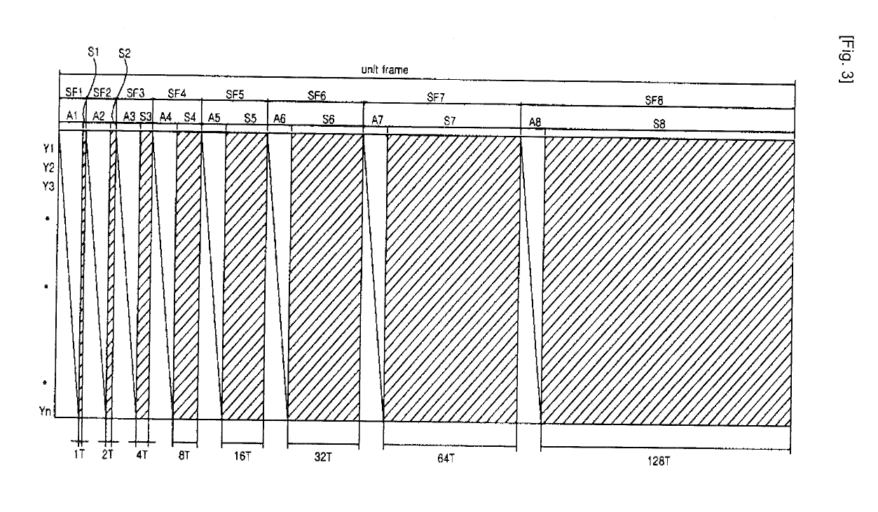

FIG. 3 is a timing diagram illustrating a method of dividing one frame into a plurality of subfields to time division drive the PDP according to an embodiment of the present invention. A unit frame can be divided into a predetermined number of, for example, 8 subfields SF1, . . . , and SF8 in order to display time division gray levels. In addition, the subfields SF1, . . . , and SF8 are divided into reset periods (not shown), address periods A1, . . . , and A8, and sustain periods S1, . . . , and S8.

Here, according to an embodiment of the present invention, the reset period can be omitted in at least one of the plurality of subfields. For example, the reset period can exist only in the initial subfield or only in the initial subfield and an intermediate subfield among all of the subfields.

In the address periods A1, . . . , and A8, display data signals are applied to the address electrodes X and scan pulses corresponding to the scan electrodes Y are sequentially applied.

In the sustain periods S1, . . . , and S8, sustain pulses are alternately applied to the scan electrodes Y and the sustain electrodes Z to generate sustain discharge in the discharge cells where wall charges are formed in the address periods A1, . . . , and A8.

The brightness of the PDP is in proportion to the number of sustain discharge pulses in the sustain discharge periods S1, . . . , and S8 of the unit frame. When one frame that forms an image is displayed by the 8 subfields and 256 gray levels, different numbers of sustain pulses can be sequentially assigned to the subfields, respectively, in the ratio of 1, 2, 4, 8, 16, 32, 64, and 128. In order to obtain the brightness of 133 gray levels, cells are addressed in a subfield 1 period, a subfield 3 period, and a subfield 8 period to perform sustain discharge.

The number of sustain discharge pulses assigned to the subfields, respectively, can vary in accordance with the weight values of the subfields in accordance with an automatic power control (APC) step. That is, in FIG. 3, it was described that one frame was divided into 8 subfields. However, the present invention is not limited to the above and the number of subfields that form one frame can vary in accordance with a design specification. For example, one frame is divided into no less than 8 subfields such as 12 or 16 subfields to drive the PDP.

In addition, the number of sustain discharges assigned to the subfields, respectively, can vary in consideration of a gamma characteristic or a panel characteristic. For example, the gray level degree assigned to a subfield 4 can be reduced from 8 to 6 and the gray level degree assigned to a subfield 6 can be increased from 32 to 34.

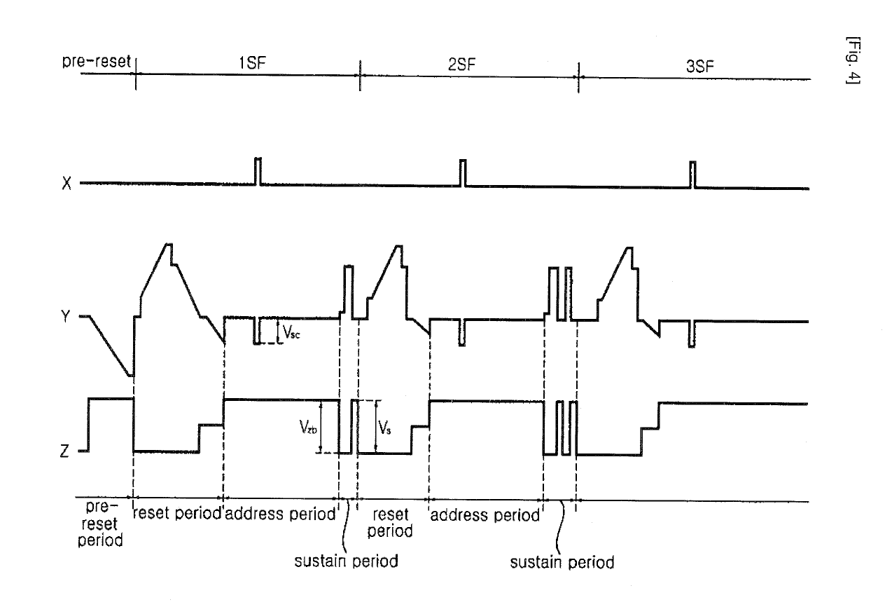

FIG. 4 is a timing diagram illustrating shapes of driving signals for driving the PDP according to an embodiment of the present invention.

The subfield can include a pre-reset period for filming positive polar wall charges on the scan electrodes Y and for forming negative polar wall charges on the sustain electrodes Z, a reset period for initializing the discharge cells of an entire screen using the distribution of wall charges formed by the pre-reset period, an address period far selecting discharge cells, and a sustain period for sustaining the discharge of the selected discharge cells.

The reset period includes a set up period and a set down period. In the set up period, rising ramp shapes Ramp-up are simultaneously applied to all of the scan electrodes so that micro-discharge is generated by all of the discharge cells and that wall charges are generated. In the set down period, falling ramp shapes Ramp-down that fall at a positive polar voltage lower than the peak voltage of the rising ramp shapes Ramp-up are simultaneously applied to all of the scan electrodes Y so that erase discharge is generated by all of the discharge cells to erase unnecessary charges among wall charges and spatial charges generated by set up discharge.

In the address period, scan signals having a negative polar scan voltage Vsc are sequentially applied to the scan electrodes and, at the same time, positive polar data signals are applied to the address electrodes X. Address discharge is generated by a voltage difference between the scan signals and the data signals and a wall voltage generated in the reset period so that cells are selected. On the other hand, in order to improve the efficiency of the address discharge, a sustain bias voltage Vzb is applied to the sustain electrodes in the address period.

In the address period, the plurality of scan electrodes Y can be divided into at least two groups to sequentially supply scan signals to the groups and each of the divided groups can be divided into at least two subgroups to sequentially supply the scan signals to the subgroups. For example, the plurality of scan electrodes Y can be divided into a first group and a second group and, after the scan signals are sequentially supplied to the scan electrodes that belong to the first group, the scan signals can be sequentially supplied to the scan electrodes that belong to the second group.

According to an embodiment of the present invention, the plurality of scan electrodes Y can be divided into a first even group and a second odd group in accordance with the positions of the scan electrodes Y. According to another embodiment of the present invention, the scan electrodes Y can be divided into a first group positioned on an upper side and a second group positioned on a lower side based on the center of the panel.

The scan electrodes that belong to the first group divided by the above-described method can be divided into a first even subgroup and a second odd subgroup or can be divided into a first subgroup positioned on an upper side and a second subgroup positioned on a lower side based on the center of the first group.

In the sustain period, sustain pulses having a sustain voltage Vs are alternately applied to the scan electrodes and the sustain electrodes so that sustain discharge is generated between the scan electrodes and the sustain electrodes in a surface discharge type.

In the sustain period, among the plurality of sustain signals alternately supplied to the scan electrodes and the sustain electrodes, the width of the first sustain signal or the last sustain signal can be larger than the widths of the remaining sustain pulses.

After the sustain discharge is generated, an erase period for erasing wall charges left in the scan electrodes or the sustain electrodes of on cells selected in the address period by generating weak discharge can be further provided after the sustain period.

The erase period can be included in all of the plurality of subfields or partial subfields and an erase signal for the weak discharge is preferably applied to the electrode where the last sustain pulse is not applied in the sustain period.

A gradually rising ramp shaped signal, a low voltage wide pulse, a high voltage narrow pulse, an exponential signal, or a half sinusoidal pulse can be used as the erase signal.

In addition, in order to generate the weak discharge, a plurality of pulses can be sequentially applied to the scan electrodes or the sustain electrodes.

The present invention is not limited to the driving shapes illustrated in FIG. 4 of signals for driving the PDP according to an embodiment of the present invention. For example, the pre-reset period can be emitted, the polarity and the voltage level of the driving signals illustrated in FIG. 4 can change if necessary, the erase signals for erasing the wall charges can be applied to the sustain electrodes after the sustain discharge is completed. In addition, single sustain driving in which the sustain signals are applied to one of the scan electrodes Y and the sustain electrodes Z to generate the sustain discharge can be performed.

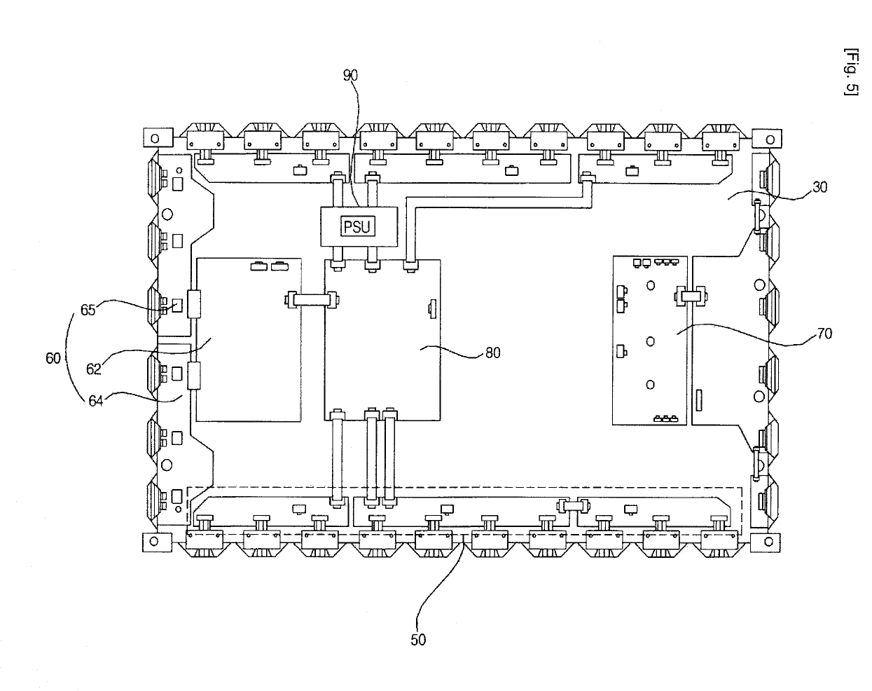

FIG. 5 illustrates the structure of a driving device for driving the PDP according to an embodiment of the present invention.

Referring to FIG. 5, a radiation frame 30 is provided on the rear surface of the panel to support the panel, to absorb heat generated by the panel, and to emit the absorbed heat. In addition, a printed circuit board (PCB) 40 for applying the driving signals to the panel is provided on the rear surface of the radiation frame 30.

The PCB 40 can include an address driver 50 for supplying the driving signals to the address electrodes of the panel, a scan driver 60 for supplying the driving signals to the scan electrodes of the panel, a sustain driver 70 for supplying the driving signals to the sustain electrodes of the panel, a driving controller 80 far controlling driving circuits, and a power supply unit (PSU) 90 for supplying a power source to the driving circuits.

The address driver 50 supplies the driving signals to the address electrodes formed on the panel so that only discharged discharge cells are selected among the plurality of discharge cells formed on the panel.

The address driver 50 can be provided on one or both of the upper side and the lower side of the panel by a single scan method or the dual scan method.

A data integrated circuit (IC) (not shown) is provided in the address driver 50 to control current applied to the address electrodes. Switching for controlling applied current is generated by the data IC so that a large amount of heat can be generated. Therefore, a heat sink (not shown) can be provided in the address driver 50 in order to remove heat generated by the controlling process.

As illustrated in FIG. 5, the scan driver 60 can include a scan sustain board 62 connected to the driving controller 80 and scan driver boards 64 for connecting the scan sustain board 62 to the panel.

The scan driver boards 64 can be divided into two parts of an upper side and a lower side, can be singular unlike in FIG. 5, or can be plural.

Scan ICs 65 for supplying the driving signals to the scan electrodes of the panel are provided in the scan driver boards 64 and the scan ICs 65 can continuously apply the reset signals, the scan signals, and the sustain signals to the scan electrodes.

The sustain driver 70 supplies the driving signals to the sustain electrodes of the panel.

The driving controller 80 performs predetermined signal processing on image signals input using signal processing information stored in a memory to convert the image signals into data to be supplied to the address electrodes and can align the converted data in the order of scanning. In addition, the driving controller 80 supplies timing control signals to the address driver 50, the scan driver 60, and the sustain driver 70 to control the driving signal supply point of time of the driving circuits.

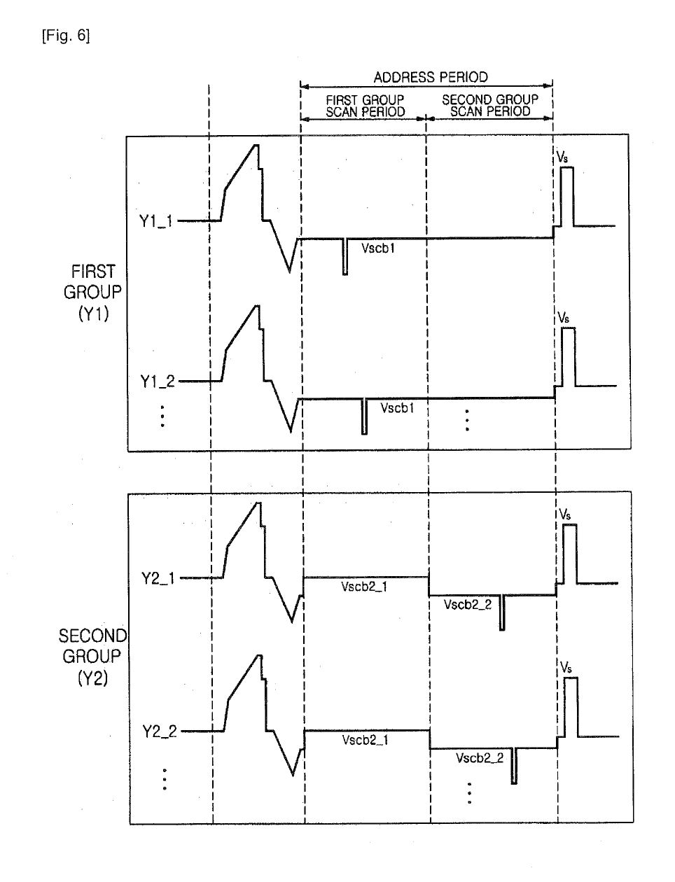

FIGS. 6 to 9 are timing diagrams illustrating a method of dividing the scan electrodes of the PDP into two groups to drive the scan electrodes according to embodiments of the present invention.

Referring to FIG. 6, the plurality of scan electrodes Y formed on the panel can be divided into at least two groups Y1 and Y2. The address period can be divided into first and second group scan periods for supplying the scan signals to the divided first and second groups. After the scan signals are sequentially supplied to the scan electrodes Y1 that belong to the first group in the first group scan period, the scan signals can be sequentially supplied to the scan electrodes Y2 that belong to the second group in the second group scan period.

For example, the plurality of scan electrodes Y can be divided into a first even group Y1 and a second odd group Y2 from the upper end of the panel in accordance with the positions on the panel. According to another embodiment, the plurality of scan electrodes Y can be divided into a first group Y1 positioned on an upper side and a second group Y2 positioned on a lower side based on the center of the panel. The plurality of scan electrodes Y can be divided other various methods than the above-described methods and the number of scan electrodes that belong to the first and second group Y1 and Y2 can vary.

Negative polar (−) charges for the address discharge are formed in the scan electrodes Y in the reset period. The driving signals supplied to the scan electrodes Y in the address period sustain the scan bias voltage and the negative polar scan signals are sequentially supplied so that the address discharge is generated.

When the plurality of scan electrodes Y are divided into first and second groups to sequentially supply the scan signals, negative polar (−) wall charges formed in the scan electrodes Y2 that belong to the second group Y2 can be lost in the first group scan period for supplying the scan signals to the first group Y1. Therefore, although the scan signals are supplied to the scan electrodes Y2 that belong to the second group Y2 in the second group scan period, address erroneous discharge in which the address discharge is not generated can be generated.

Therefore, as illustrated in FIG. 6, a scan bias voltage Vscb2_1 supplied to the second group Y2 is increased after the reset period before the second group scan period in which the scan signals are supplied to the second group Y2, for example, in the first group scan period to reduce the loss of the negative polar (−) wall charges formed in the scan electrodes that belong to the second group Y2.

That is, in the first group scan period, the scan bias voltage Vscb2_1 larger than the scan bias voltage Vscb1 supplied to the first group scan electrodes Y1 is supplied to the second group scan electrodes Y2 so that the address erroneous discharge can be reduced.

The scan bias voltage Vscb2_1 supplied to the second group scan electrodes Y2 in the first group scan period is preferably lower than the sustain voltage Vs. When the scan bias voltage Vscb2_1 is lower than the sustain voltage Vs, it is possible to prevent power consumption from unnecessarily increasing and to reduce the generation of brilliant spot erroneous discharge as the amount of the wall charges of the scan electrodes is too large.

In the first group scan period, a negative polar third scan bias voltage Vscb3 is applied to the first scan group electrode Y1. When the scan signals are applied to the scan electrodes, a potential difference between the san signals and the data signals having a negative polar bias voltage and applied to the address electrodes increases so that discharge is easily generated.

In order to increase a potential difference between the scan signals and positive polar data signals supplied to the address electrodes X to facilitate the address discharge, the scan bias voltage Vscb1 supplied to the first group scan electrodes Y1 in the first group scan period and the scan bias voltage Vscb2_2 supplied to the second group scan electrodes Y2 in the second group scan period can be negative polar voltages. Therefore, in consideration of facility of forming the driving circuits, the scan bias voltage Vscb2_1 supplied to the second group scan electrodes Y2 in the first group scan period can be a ground voltage GND and the scan bias voltage Vcb1 supplied to the first group scan electrodes Y1 in the address period can be uniform.

Referring to FIG. 6, the scan bias voltage supplied to the second group scan electrodes Y2 in the address period can change. To be specific, the scan bias voltage Vscb2_1 supplied to the second group scan electrodes Y2 in the first group scan period of the address period can be larger than the scan bias voltage Vscb2_2 supplied to the second group scan electrodes Y2 in the second group scan period.

When the plurality of scan electrodes are divided into a first even group Y1 and a second odd group Y2, as described above, the different scan bias voltages Vscb1 and Vscb2_1 are supplied to the first and second group scan electrodes Y1 and Y2 in the first group scan period so that the influence of interference between adjacent discharge cells can be reduced.

In addition, the scan bias voltage Vsc2_1 supplied to the scan electrodes Y2 that belong to the second group in the first group scan period can have a value no less than 2. In such a case, the higher scan bias voltage Vscb2_1 can be supplied to the scan electrodes where the scan signals are supplied later rather than to the scan electrodes where the scan signals are supplied first among the second group scan electrodes Y2 in the first group scan period. Therefore, it is possible to effectively reduce the loss of the wall charges formed in the scan electrodes in the reset period.

The driving shapes illustrated with reference to FIG. 6 can be applied to partial subfields among the plurality of subfields that constitute one frame, for example, to at least one subfield among the subfields after the second subfield.

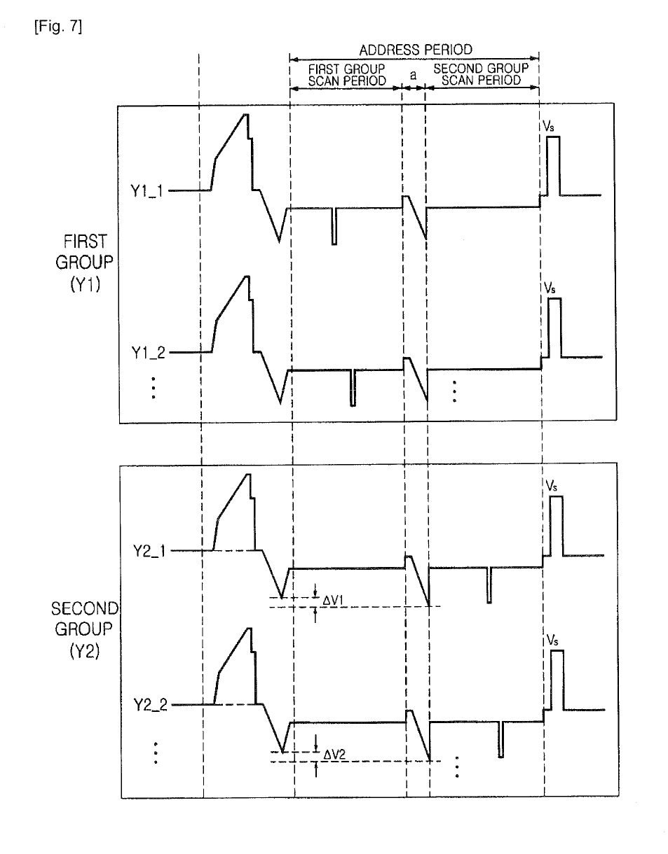

FIG. 7 is a timing diagram illustrating driving signal shapes in which the plurality of scan electrodes Y are divided into the first and second groups to sequentially supply scan signals according to another embodiment of the present invention. Description of the same components of the driving signal shapes illustrated in FIG. 7 as the components of the driving signal shapes illustrated in FIG. 6 will be omitted.

Referring to FIG. 7, an intermediate period a in which gradually falling signals are supplied to the scan electrodes Y can exist between the first group scan period in which the scan signals are sequentially supplied to the first group scan electrodes Y1 and the second group scan period in which the scan signals are sequentially supplied to the second group scan electrodes Y2.

As described above, in the set down period of the reset period, gradually falling set down signals are supplied to the scan electrodes Y to erase unnecessary charges among the wall charges formed in the set up period.

When the scan electrodes Y are divided into a plurality of groups to sequentially supply the scan signals, since the negative polar (−) wall charges formed in the scan electrodes Y2 that belong to the second group scan electrodes Y2 can be lost in the first group scan period, the amount of wall charges formed in the second group scan electrodes Y2 is made larger than the amount of wall charges formed in the first group scan electrodes Y1 at the point of time where the address period starts so that the loss of the wall charges can be compensated for.

For example, as illustrated in FIG. 7, the lowermost voltages of the set down signals supplied to the second group scan electrodes Y2 in the reset period are increased (the absolute values of the lowermost voltages are reduced) so that the amount of the wall charges formed in the second group scan electrodes Y2 at the point of time where the address period starts can be increased. In addition, gradually falling signals are supplied to the second group scan electrodes Y2 after the first group scan period is terminated so that unnecessary wall charges can be erased.

Therefore, the lowermost voltage of a first set down signal supplied to the second group scan electrodes Y2 in the reset period can be different from the lowermost voltage of a second set down signal supplied to the second group scan electrodes Y2 in the intermediate period a. To be specific, the lowermost voltage of the first set down signal can be higher than the lowermost voltage of the second set down signal.

In addition, in order to effectively compensate for the loss of the wall charges formed in the second group scan electrodes Y2, the lowermost voltage of the first set down signal supplied to the second group scan electrodes Y2 in the reset period can have a value no less than 2. In such a case, the set down signal having the higher lowermost voltage can be supplied to the scan electrodes where the scan signals are supplied later rather than to the scan electrodes where the scan signals are supplied first among the second group scan electrodes Y2.

For example, a difference DV2 between the lowermost voltages of the first and second set down signals supplied to a second scan electrode Y2_2 in the second group Y2 can be larger than a difference DV1 between the lowermost voltages of the first and second set down signals supplied to a first scan electrode Y2_1.

In consideration of facility of forming the driving circuits for generating the driving signals of the above-described shapes, as illustrated in FIG. 7, the second set down signal that gradually falls can be also supplied to the first group scan electrodes Y1 in the intermediate period a between the first and second group scan periods. That is, when the second set down signal is supplied to only the second group scan electrodes Y2 in the intermediate period a, the structures of circuits for supplying the set down signals can have to vary by the first and second groups.

Referring to FIG. 7, the lowermost voltages of the set down signals supplied to the first group scan electrodes Y1 in the reset period can be lower than the lowermost voltages of the set down signals supplied to the second group scan electrodes Y2. In addition, in consideration of facility of brining the circuits, the lowermost voltage of the first set down signal supplied to the first group scan electrodes Y1 in the reset period can be equal to the lowermost voltage of the second set down signal supplied to the first and second group scan electrodes Y1 and Y2 in the intermediate period a.

In order to easily form the driving circuits, the falling slopes of the first and second set down signals can be equal to each other. In such a case, the widths of the set down signals, that is, the falling times of the first and second set down signals are controlled so that the lowermost voltages of the first and second set down signals can vary as described above.

In addition, the magnitude of the lowermost voltage of the first set down signal supplied to the second group scan electrodes Y2 in the reset period can be in inverse proportion to the magnitude of the lowermost voltage of the second set down signal supplied to the second group scan electrodes Y2 in the intermediate period a. That is, as the lowermost voltage of the first set down signal supplied to one of the second group scan electrodes Y2 in the reset period is reduced, the lowermost voltage of the second set down signal supplied to the scan electrodes in the intermediate period a can increase. Since the amount of the wall charges formed in the scan electrodes is reduced at the point of time where the address period starts as the lowermost voltage of the first set down signal supplied to the second group scan electrodes Y2 in the reset period is reduced, the lowermost voltage of the second set down signal supplied to the scan electrodes in the intermediate period a is increased so that the erase amount of the wall charges formed in the scan electrodes can be reduced and that the second group scan electrodes Y2 can be sustained to have a proper wall charge state for the address discharge.

Unlike in FIG. 7, the set down signals may not be supplied to the second group scan electrodes Y2 in the reset period. Therefore, the amount of the negative polar (−) wall charges formed in the second group scan electrodes Y2 at the point of time where the address period starts can be increased.

The driving signal shapes described with reference to FIG. 7 can be applied to partial subfields among the plurality of subfields that constitute one frame, for example, to at least one subfield among the subfields after the second subfield. In addition, as illustrated in FIG. 6, the scan bias voltage supplied to the second group scan electrodes Y2 can vary.

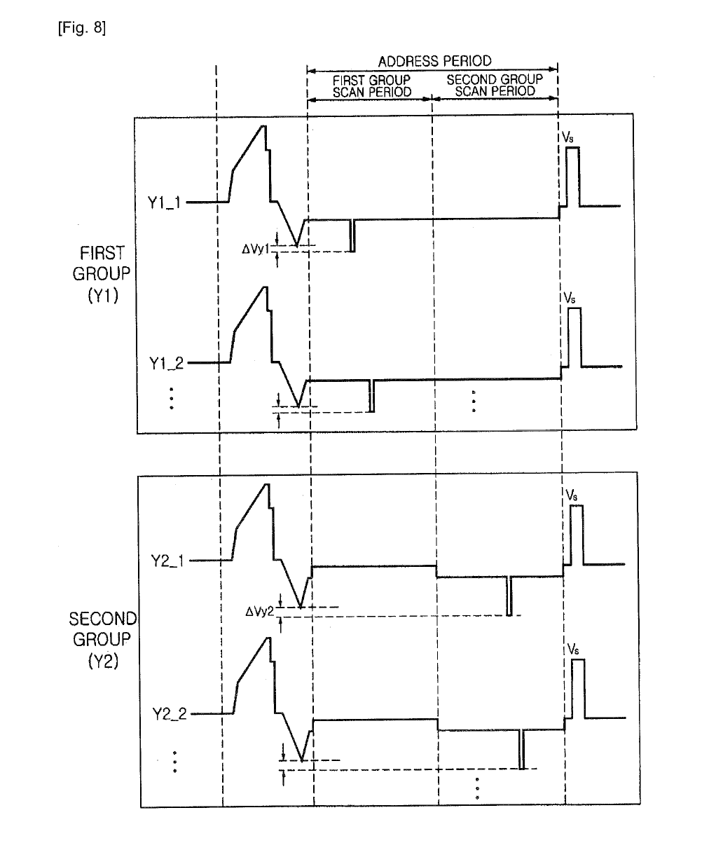

Referring to FIG. 8, the lowermost voltages of the set down signals supplied to the first and second scan group electrodes Y1 and Y2 in the reset period can be made higher than the lowermost voltages of the scan signals. Therefore, the amount of the wall charges formed in the first and second scan group electrodes Y1 and Y2 at the point of time where the address period starts is increases so that the address discharge can be stably generated.

As described above, in order to compensate for the loss of the wall charges formed in the second group scan electrodes Y2 in the first group scan period, the lowermost voltages of the set down signals supplied to the second group scan electrodes Y2 in the reset period can be increased. Therefore, a difference DVy2 between the lowermost voltages of the set down signals and the scan signals supplied to the second scan group electrodes Y2 can be larger than a difference DVy1 between the set down signals and the scan signals supplied to the first scan group electrodes Y1.

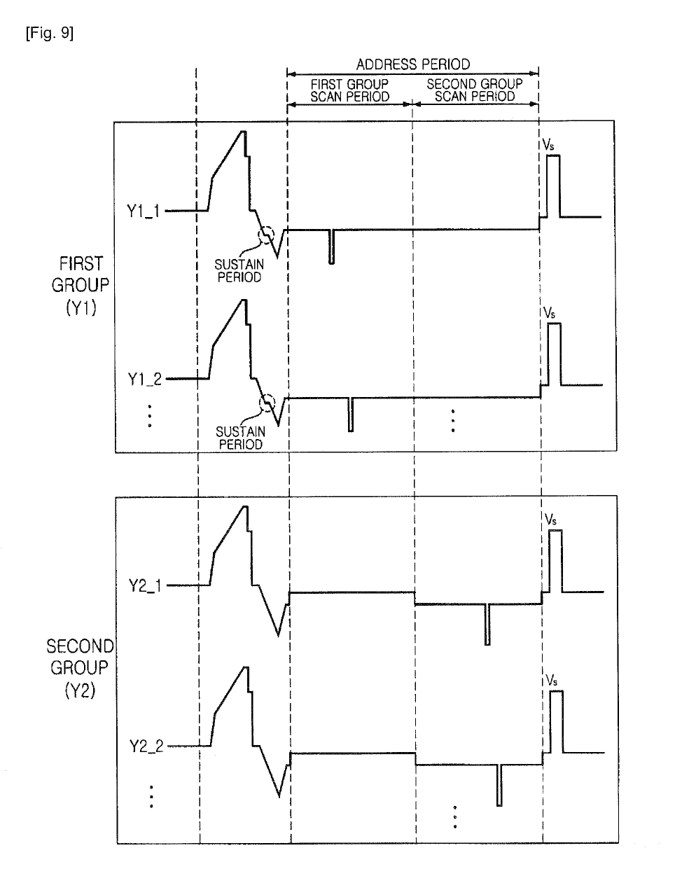

Referring to FIG. 9, the falling period of the set down signals supplied to the scan electrodes in the reset period can have discontinuous shapes. That is, the falling period of the set down signals can include a first falling period that gradually falls to a first voltage, a sustain period that sustains the first voltage, and a second falling period that gradually falls from the first voltage. In addition, the set down signals can include the at least two sustain periods.

As described above, the set down signals having the discontinuous falling periods are supplied to the scan electrodes in the reset period so that the amount of the wall charges formed in the scan electrodes at the point of time where the address period starts can be increased and that the address discharge can be stabilized.

As illustrated in FIG. 9, the set down signals having the discontinuous falling periods can be supplied to at least one of the first group scan electrodes Y1 and to at least one of the second group scan electrodes Y2 or to all of the first and second group scan electrodes Y1 and Y2.

The driving shapes described with reference to FIGS. 8 and 9 can be applied to partial subfields among the plurality of subfields that constitute one frame, for example, to at least one subfield among the subfields after the second subfield.

In addition, the driving signal shapes illustrated in FIGS. 6 to 9 can be simultaneously applied to one of the plurality of subfields.

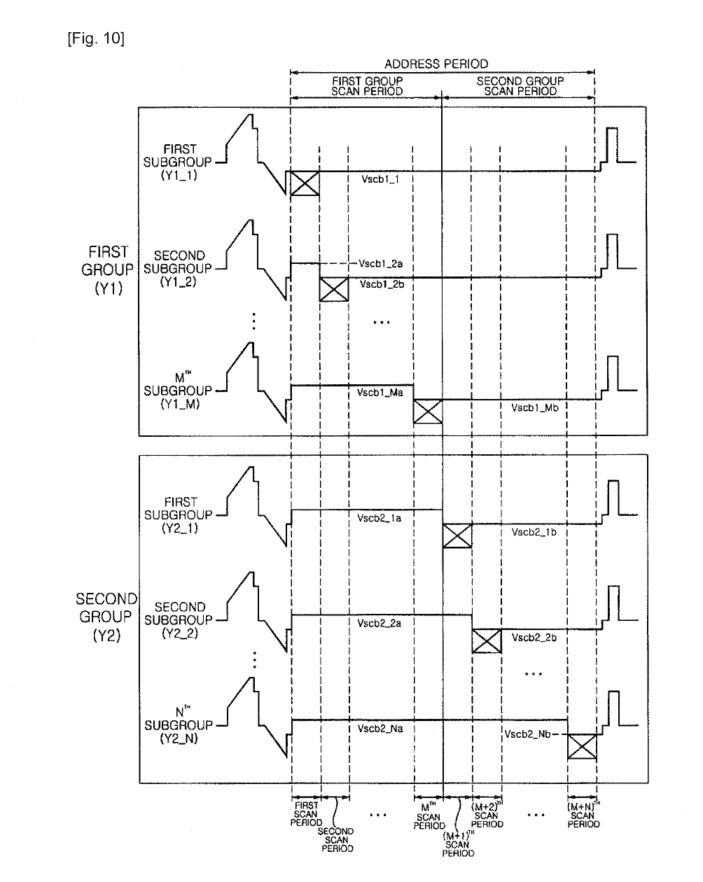

FIG. 10 is a timing diagram illustrating a method of dividing scan electrode groups divided by the above-describe method into at least two subgroups to be driven according to embodiments of the present invention.

Referring to FIG. 10, the plurality of scan electrodes Y formed on the PDP can be divided into the first and second groups Y1 and Y2. For example, the plurality of scan electrodes Y can be divided into a first even group Y1 and a second odd group Y2 from the upper end of the panel in accordance with the positions of the scan electrodes Y. According to another embodiment, the scan electrodes Y can be divided into the first group Y1 positioned on an upper side and the second group Y2 positioned on a lower side based on the center of the panel. The plurality of scan electrodes Y can be divided by other various methods than the above-described methods and the number of scan electrodes that belong to the first and second groups Y1 and Y2 can vary.

In addition, the first and second group scan electrodes Y1 and Y2 can be divided into a plurality of subgroups. In such a case, the scan signals are sequentially supplied to the plurality of scan electrodes in the order of the first and second groups and the scan signals can be sequentially supplied to the plurality of divided subgroups in the first and second groups.

The number M of subgroups that belong to the first group can be different from the number N of subgroups that belong to the second group.

Referring to FIG. 10, the scan signals are sequentially supplied to the plurality of subgroups Y1_1, . . . , and Y1_M and Y2_1, . . . , and Y2_N in scan periods (first to (M+N)th scan periods) corresponding to the plurality of subgroups Y1_1, . . . , and Y1_M and Y2_1, . . . , and Y2_N. That is, the scan signals can be sequentially supplied to the first subgroup scan electrodes Y1_1 that belong to the first group in the first scan period, the scan signals can be sequentially supplied to the second subgroup scan electrodes Y1_2 that belong to the first group in the second scan period, and the scan signals can be sequentially supplied to the first subgroup scan electrodes Y2_1 that belong to the second group in an (M+1)th scan period.

As described above, the negative polar (−) wall charges formed in the subgroups in the reset period can be lost before a period where the scan signals are supplied so that address erroneous discharge can be generated. For example, in the case of the second subgroup scan electrodes Y1_2 that belong to the first group, the wall charges formed in the reset period can be lost in the first scan period. In the case of the first subgroup scan electrodes Y2_1 that belong to the second group, the wall charges formed in the reset period are lost in the first to Mth scan periods so that the address erroneous discharge can be generated.

In order to reduce the loss of the wall charges, the magnitude of the scan bias voltage can be increased in a period from the point of time where the address period starts before the scan signals are supplied to corresponding subgroups.

The magnitude of the scan bias voltage increased as described above is preferably smaller than the magnitude of the sustain voltage Vs. When the scan bias voltage is lower than the sustain voltage Vs, it is possible to prevent unnecessary power consumption from increasing and to reduce the generation of the brilliant point erroneous discharge caused as the amount of the wall charges of the scan electrodes increases too much.

That is, in the case of the second subgroup scan electrodes Y1_2 that belong to the first group, the scan bias voltage Vscb1_2a supplied in the first scan period can be made higher than the scan bias voltage Vscb1_2b supplied in the periods after the first scan period, that is, the second to (M+N)th scan periods. In addition, in the case of the Mth subgroup scan electrodes Y1_M that belong to the first group, a scan bias voltage Vscb1_Ma supplied in the first to (M−1)th scan periods can be made higher than a scan bias voltage Vscb1_Mb supplied in the Mth to (M+N)th scan periods.

In the case of the second group, in the case of the first subgroup scan electrodes Y2_1, a scan bias voltage Vscb2_1a supplied in the first to Mth scan periods can be made higher than a scan bias voltage Vscb2_1b supplied in the (M+1)th to (M+N)th scan periods. In the second subgroup scan electrodes Y2_2, a scan bias voltage Vscb2_2a supplied in the first to (M+1)th scan periods can be made higher than a scan bias voltage Vscb2_2b supplied in the (M+2)th to (M+N)th scan periods. In the case of Nth subgroup scan electrodes Y2_N, a scan bias voltage Vscb2_Na supplied in the first to ((M+N)-1)th scan periods can be made higher than a scan bias voltage Vscb2_Nb supplied in the (M+N)th scan period.

As described above, according to the driving signals according to an embodiment of the present invention, scan bias voltages supplied to arbitrary two subgroups that belong to the first group at least one point of time of the address period can vary, scan bias voltages supplied to arbitrary two subgroups that belong to the second group at least one point of time of the address period can vary, and scan bias voltages supplied to a subgroup that belongs to the first group and a subgroup that belongs to the second group at least one point of time of the address period can vary.

Referring to FIG. 10, in the case of the first group, the scan bias voltages supplied in the first scan period vary with the first and second subgroups Y1_1 and Y1_2 or the first subgroup and the Mth subgroup Y1_1 and Y1_M and scan bias voltages supplied in the second to (M−1)th scan periods vary with the second subgroup and the Mth subgroup Y1_2 and Y1_M.

In the case of the second group, the scan bias voltage supplied in the (M+1)th scan period varies with the first and second subgroups Y2_1 and Y2_2 or the first subgroup and the Nth subgroup Y2_1 and Y2_M. Scan bias voltages supplied in the (M+2)th to ((M+N)-1)th scan periods vary with the second subgroup and the Nth subgroup Y2_2 and Y2_N.

In addition, a scan bias voltage supplied in the first scan period varies with the first subgroup Y1_1 that belongs to the first group and a subgroup that belongs to the second group and a scan bias voltage supplied in the second scan period varies with a second subgroup Y1_2 that belongs to the first group and a subgroup that belongs to the second group, and a scan bias voltage supplied in the Mth scan period varies with an Mth subgroup Y1_M that belongs to the first group and a subgroup that belongs to the second group.

As described above, negative polar scan bias voltages can be supplied in periods where the scan signals are supplied in the plurality of subgroups.

In order to easily form the driving circuits, the scan bias voltages Vscb1_1, Vscb1_2b, . . . , Vscb1_Mb, Vscb2_1b, . . . , Vscb2_2b, . . . , and Vscb2_Nb in the periods where the scan signals are supplied can be equal to each other and the scan bias voltages Vscb1_2a, . . . , Vscb1_Ma, Vscb2_1a, . . . , Vscb2_2a, . . . , and Vscb2_Na supplied in the periods before the scan signals are supplied can be ground voltages GND.

That is, since the above-described voltage levels are used, only the switching timing of the driving circuits are controlled without remarkably changing the structures of the driving circuits that supply the driving signal shapes described with reference to FIGS. 4 to 9 so that the driving signals having the shapes illustrated in FIG. 10 can be supplied to the panel.

In addition, as described above, since the loss of the wall charges can increase as the supply of the scan signals is delayed, the magnitudes of the scan bias voltages Vscb1_2a, . . . , Vscb1_Ma, Vscb2_1a, . . . , Vscb2_2a, . . . , and Vscb2_Na supplied to the subgroups, respectively, in the periods before the scan signals are supplied can increase as it is positioned later in the driving order. That is, in the first group, the scan bias voltage Vscb1_Ma supplied to the Mth subgroup Y1_M in the first scan period can be higher than the scan bias voltage Vscb1_2a supplied to the second subgroup Y1_2. In the second group, the scan bias voltage Vscb2_2a supplied to the second subgroup Y2_2 in the first scan period can be higher than the scan bias voltage Vscb2_1 a supplied to the first subgroup Y2_1. In addition, the scan bias voltages supplied to the N subgroups that belong to the second group Y2 in the first scan period can be higher than the scan bias voltages supplied to the M subgroups that belong to the first group Y1.

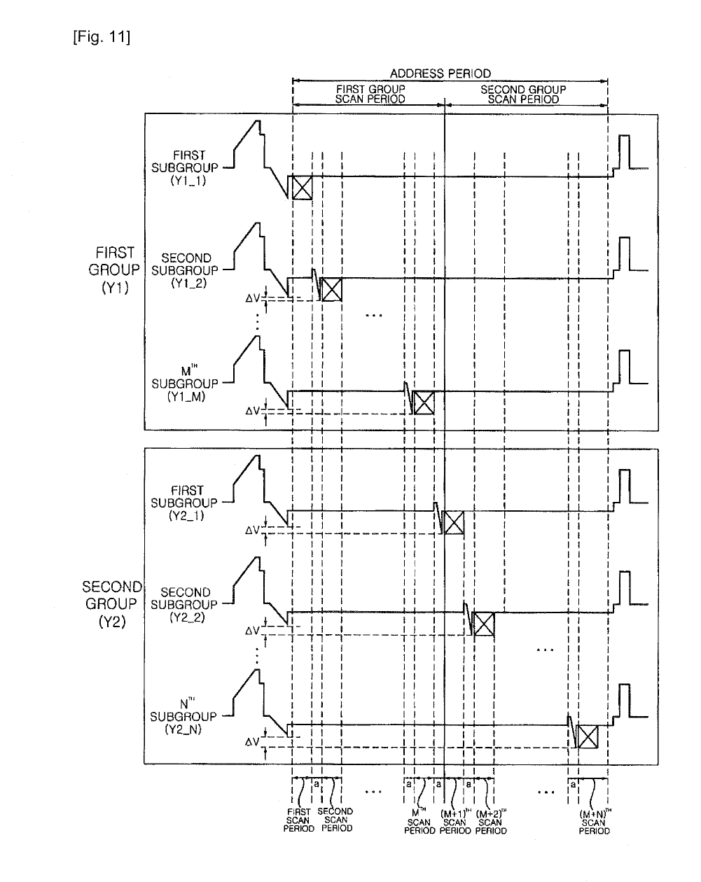

FIG. 11 is a timing diagram illustrating a method of dividing the plurality of scan electrodes into the above-described subgroups to be driven according to other embodiments. Description of the same components of the driving shapes illustrated in FIG. 11 as the components of the driving shapes illustrated in FIG. 10 will be emitted.

Referring to FIG. 11, gradually falling signals are supplied in the intermediate period a between two adjacent scan periods among the plurality of scan periods (the first to (M+N)th scan periods) in which the scan signals are supplied to the plurality of subgroups so that unnecessary wall charges can be erased before the scan signals are supplied.

In addition, in order to increase the amount of the wall charges formed in the scan electrodes at the point of time where the address period starts to compensate for the loss of the wail charges generated hereinafter, the lowermost voltages of the set down signals supplied to the scan electrodes in the reset period can be increased (the absolute values of the lowermost values are reduced).

For example, as illustrated in FIG. 11, in the second to Mth subgroups that belong to the first group or the subgroups that belong to the second group, the lowermost voltage of the first set down signal supplied in the reset period can be increased to increase the amount of the wall charges of the scan electrodes at the point of time where the address period starts and the second set down signal is supplied immediately before the scan periods of the subgroups to erase unnecessary wall charges so that a wall charge state proper for the address discharge can be sustained.

In order to easily form the driving circuits, the falling slopes of the first and second set down signals can be equal to each other. In such a case, the widths of the set down signals, that is, the falling times of the first and second set down signals are controlled so that the lowermost voltages of the first and second set down signals can vary as described above.

In addition, in order to effectively compensate for the loss of the wall charges formed in the scan electrodes, the lowermost voltage of the first set down signal supplied to the scan electrodes in the reset period can have a value no less than 2. In such a case, the lowermost voltage of the first set down signal of the subgroup before which the scan periods are positioned can be lower than the lowermost voltage of the first set down signal of the subgroup after which the scan periods are positioned. For example, the lowermost voltage of the first set down signal supplied to the second subgroup Y1_2 that belongs to the first group can be lower than the lowermost voltage of the first set down signal supplied to the Mth subgroup Y1_M. The lowermost voltage of the first set down signal supplied to the first subgroup Y2_1 that belongs to the second group can be lower than the lowermost voltage of the first set down signal supplied to the second subgroup Y2_2. Therefore, a difference DV between the lowermost voltages of the first and second set down signals of the subgroups increases in a subgroup after which the scan periods exist.

The magnitude of the lowermost voltage of the first set down signal supplied in the reset period can be in inverse proportion to the magnitude of the lowermost voltage of the second set down signal supplied in the intermediate period a. That is, as the lowermost voltage of the first set down signal supplied to a subgroup in the reset period is reduced, the lowermost voltage of the second set down signal supplied to the subgroup in the intermediate period a can be increased.

Unlike in FIG. 11, in the remaining subgroups excluding the first subgroup Y1_1 that belongs to the first group, the set down signals may not be supplied in the reset period. Therefore, the amount of the negative polar (−) wall charges formed in the scan electrodes at the point of time where the address period starts can increase.

In order to easily form and control the driving circuits, the slope of the first set down signal supplied in the reset period can be equal to the slope of the second set down signal supplied in the intermediate period a and the lowermost voltage of the second set down signal can be equal to the lowermost voltage of the first set down signal supplied to the first subgroup Y1_1 that belongs to the first group in the reset period. In addition, in the remaining subgroups excluding the first subgroup Y1_1 that belongs to the first group, the lowermost voltage of the first set down signal supplied in the reset period can be equal to the lowermost voltage of the second set down signal.

That is, since the above-described voltage levels are used, only the switching timing of the driving circuits is controlled without remarkably changing the structures of the conventional driving circuits so that the driving signals having the shapes illustrated in FIG. 11 can be supplied to the panel.

In addition, in order to easily form and control the driving circuits, in the intermediate periods a illustrated in FIG. 11, the second set down signal can be simultaneously supplied to the plurality of subgroups.

The driving shapes described with reference to FIGS. 10 and 11 can be applied to partial subfields among the plurality of subfields that constitute one frame, for example, to at least one subfield among the subfields after the second subfield.

In addition, the driving signal shapes illustrated in FIGS. 10 to 11 can be simultaneously applied to one of the plurality of subfields and, if necessary, the driving signal shapes illustrated in FIGS. 6 to 9 can be applied together.

Hereinafter, detailed embodiments of a method of dividing the scan electrodes into the plurality of subgroups to be driven will be described taking an example of dividing the first and second groups into two subgroups, respectively, to sequentially supply the scan signals.

The plurality of scan electrodes Y formed on the PDP can be divided into the first and second groups Y1 and Y2. For example, the plurality of scan electrodes Y can be divided into a first even group Y1 and a second odd group Y2 from the upper end of the panel in accordance with the positions of the scan electrodes Y can be divided into a first group Y1 positioned on an upper side and a second group Y2 positioned on a lower side based on the center of the panel according to another embodiment.

In addition, the scan electrodes Y1 that belong to the first group are divided into a first subgroup and a second subgroup and the scan electrodes Y2 that belong to the second group can be divided into a third subgroup and a fourth subgroup.

In a method of dividing the first and second groups into two subgroups, respectively, according to an embodiment of the present invention, the scan electrodes Y1 that belong to the first group can be divided into a first even subgroup and a second odd subgroup Y2 or can be divided into a first subgroup positioned on an upper side and a second subgroup positioned on a lower side based on the center of the first group. In addition, the plurality of scan electrodes can be divided into at least bur subgroups using various other methods than the above methods.

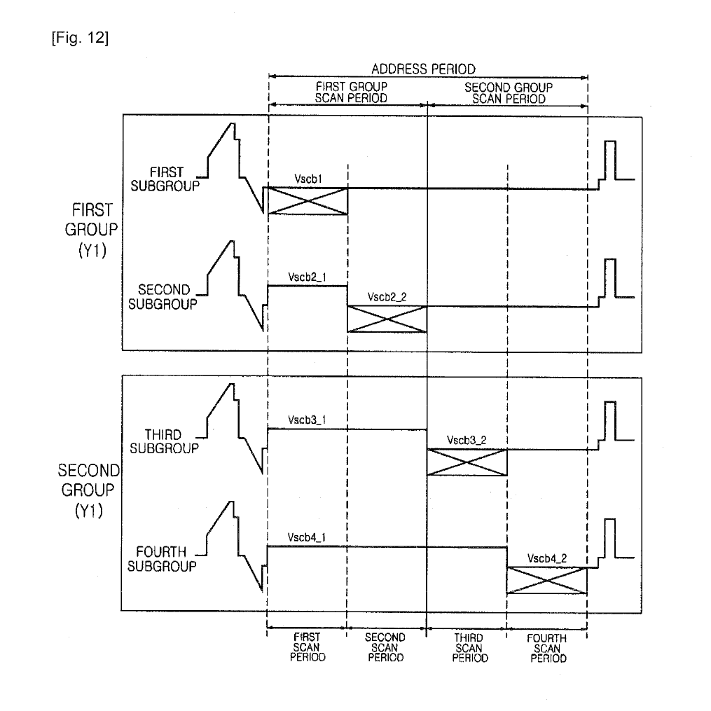

Referring to FIG. 12, the scan bias voltage Vscb1 supplied to the first subgroup scan electrodes in the first scan period can be different from the scan bias voltage Vscb2_1 supplied to the second subgroup scan electrodes. In addition, the scan bias voltage Vscb2_1 supplied to the second subgroup scan electrodes in the first scan period in order to reduce the loss of the wall charges of the second subgroup scan electrodes generated in the first scan period can be higher than the scan bias voltage Vscb1 supplied to the first subgroup scan electrodes.

A scan bias voltage Vscb3_2 supplied to third subgroup scan electrodes in a third scan period can be different from a scan bias voltage Vscb4_1 supplied to fourth subgroup scan electrodes. The scan bias voltage Vscb4_1 supplied to the fourth subgroup scan electrodes in the third scan period in order to reduce the loss of the wall charges of the fourth subgroup scan electrodes generated in the first to third scan periods can be higher than the scan bias voltage Vscb3_2 supplied to the third subgroup scan electrodes.

In addition, the scan bias voltage Vscb1 supplied to the first subgroup scan electrodes in the first scan period can be different from the scan bias voltages Vscb3_1 and Vscb4_1 supplied to the third and fourth subgroup scan electrodes. The scan bias voltages Vscb3_1 and Vscb4_1 supplied to the third and fourth subgroup scan electrodes in the first scan period in order to reduce the loss of the wall charges of the third and fourth subgroup scan electrodes generated in the first scan period can be higher than the scan bias voltage Vscb1 supplied to the first subgroup scan electrodes.

Furthermore, the scan bias voltage Vscb2_2 supplied to the second subgroup scan electrodes in the second scan period can be different from the scan bias voltages Vscb3_1 and Vscb4_1 supplied to the third and fourth subgroup scan electrodes. The scan bias voltages Vscb3_1 and Vscb4_1 supplied to the third and fourth subgroup scan electrodes in the second scan period in order to reduce the loss of the wall charges of the third and fourth subgroup scan electrodes generated in the second scan period can be higher than the scan bias voltage Vscb2_2 supplied to the second subgroup scan electrodes.

As described above, in order to effectively reduce the loss of the wall charges formed in the scan electrodes, the magnitude of the scan bias voltage can increase in the order of Vscb1, Vscb2_1, Vscb3_1, and Vscb4_1.

In order to easily form and control the driving circuits, the magnitudes of Vscb2_1, Vscb3_1, and Vscb4_1 can be equal to each other and the magnitudes of Vscb1, Vscb2_2, Vscb3_2, and Vscb4_2 can be equal to each other.

The high scan bias voltages Vscb2_1, Vscb3_1, and Vscb4_1 are preferably lower than the sustain voltage Vs. When the scan bias voltages Vscb2_1, Vscb3_1, and Vscb4_1 are lower than the sustain voltage Vs, it is possible to prevent unnecessary power consumption from increasing and to reduce the generation of the brilliant point erroneous discharge caused as the amount of the wall charges of the scan electrodes increases too much.

The first group can include even scan electrodes among the plurality of scan electrodes formed on the panel and the second group can include odd scan electrodes among the plurality of scan electrodes. In addition, the first and second subgroups can include even scan electrodes and odd scan electrodes that belong to the first group and the third and fourth subgroups can include even scan electrodes and odd scan electrodes among the scan electrodes that belong to the second group.

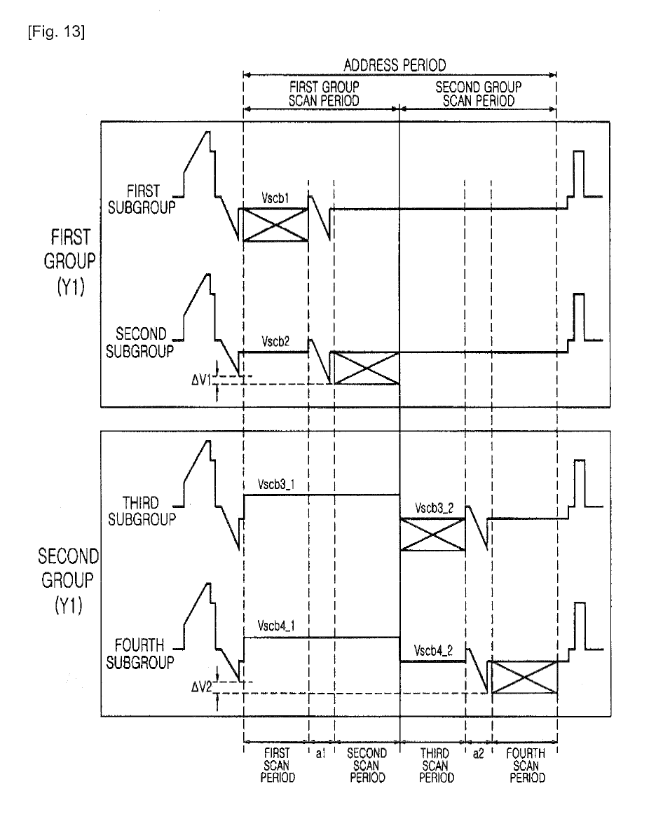

Referring to FIG. 13, the scan bias voltages Vscb1 and Vscb2 supplied to the first group scan electrodes in the first group scan period can be different from the scan bias voltages Vscb3-1 and Vscb4_1 supplied to the second group scan electrodes. In addition, the scan bias voltages Vscb3_1 and vscb4_1 supplied to the second group scan electrodes in the first scan period in order to reduce the loss of the wall charges of the second group scan electrodes generated in the first group scan period can be higher than the scan bias voltages Vscb1 and Vscb2 supplied to the first group scan electrodes.

In addition, in order to effectively reduce the loss of the wall charges formed in the scan electrodes, the magnitude of the scan bias voltage can increase in the order of Vscb1, Vscb2, Vscb3_1, and Vscb4_1.

In order to easily farm and control the driving circuits, the magnitudes of Vscb1, Vscb2, Vscb3_2, and Vscb4_2 can be equal to each other and the magnitudes of Vscb3_1 and Vscb4_1 can be equal to each other.

The high scan bias voltages Vscb3_1 and Vscb4_1 are preferably lower than the sustain voltage Vs. When the scan bias voltages Vscb3_1 and Vscb4_1 are lower than the sustain voltage Vs, it is possible to prevent unnecessary power consumption from increasing and to reduce the generation of the brilliant point erroneous discharge caused as the amount of the wall charges of the scan electrodes increases too much.

As illustrated in FIG. 13, gradually falling signals can be supplied to the first and second subgroup scan electrodes in a first intermediate period a1 between the first and second scan periods and gradually falling signals can be supplied to the third and fourth subgroup scan electrodes in a second intermediate period a2 between the third and fourth scan periods. In this case, the lowermost voltages of the set down signals supplied to the second subgroup scan electrodes in the reset period in order to compensate for the loss of the wall charges of the scan electrodes can be higher than the lowermost voltages of the set down signals supplied to the first subgroup scan electrodes and the lowermost voltages of the set down signals supplied to the fourth subgroup scan electrodes in the reset period can be higher than the lowermost voltages of the set down signals supplied to the third subgroup scan electrodes.

In order to easily form and control the driving circuits, the lowermost voltages of signals supplied in the first and second intermediate periods a1 and a2 can be equal to the lowermost voltages of set down signals supplied to the first and third subgroups in the reset period. Therefore, the lowermost voltages of the set down signals supplied to the second subgroup in the reset period can be different from the lowermost voltages of signals supplied in the first intermediate period by DV1 and the lowermost voltages of the set down signals supplied to the fourth subgroup in the reset period can be different from the lowermost voltages of signals supplied in the second intermediate period by DV2.

In addition, in order to effectively compensate for the loss of the wall charges of the scan electrodes, the DV2 can be larger than DV1.

Unlike in FIG. 13, a signal supplied to the first subgroup in the first intermediate period a1 or a signal supplied to the third subgroup in the second intermediate period a2 can be omitted and gradually falling signals can be supplied to at least one of the third and fourth subgroups in the first intermediate period a1 or gradually falling signals can be supplied to at least one of the first and second subgroups in the second intermediate period a2.

The first group can include even scan electrodes among the plurality of scan electrodes formed on the panel and the second group can include odd scan electrodes among the plurality of scan electrodes. In addition, the first and second subgroups can include scan electrodes positioned on an upper side and scan electrodes positioned on a lower side among the scan electrodes that belong the first group and the third and fourth subgroups can include scan electrodes positioned on an upper side and scan electrodes positioned on a lower side among the scan electrodes that belong to the second group.

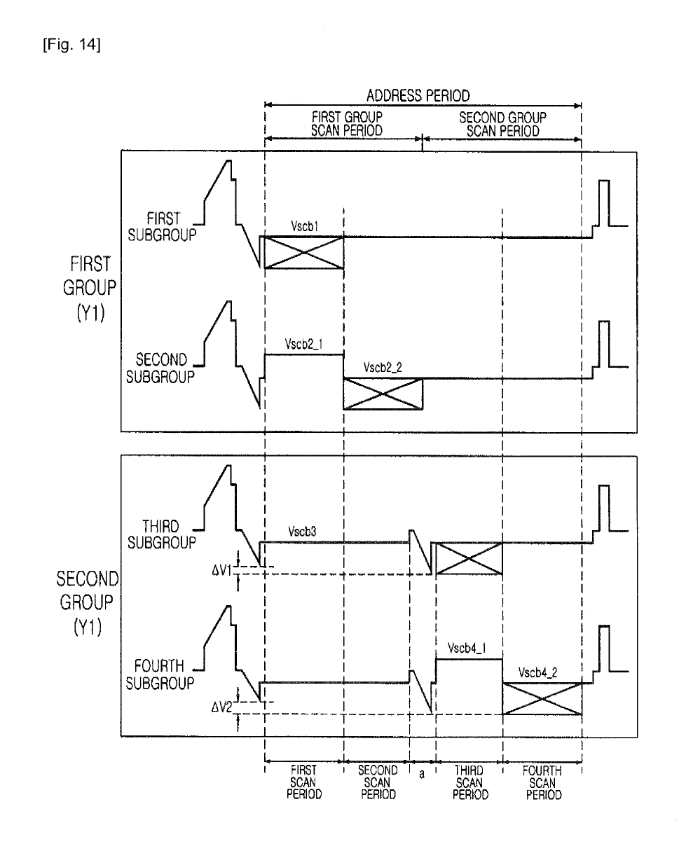

Referring to FIG. 14, gradually falling signals can be supplied to the second group scan electrodes Y2 in the intermediate period a between the first and second group scan periods. In this case, the lowermost voltages of the set down signals supplied to the second group scan electrodes Y2 in the reset period in order to compensate for the loss of the wall charges of the scan electrodes can be higher than the lowermost voltages of signals supplied to the second group scan electrodes Y2 in the intermediate period a.

In order to easily form and control the driving circuits, the lowermost voltages of signals supplied to the second group scan electrodes Y2 in the intermediate period a can be equal to the lowermost voltages of the set down signals supplied to the scan electrodes Y1 in the reset period. Therefore, the lowermost voltages of the set down signals supplied to the third subgroup in the reset period can be different from the lowermost voltages of signals supplied to the third subgroup in the intermediate period a by DV1 and the lowermost voltages of the set down signals supplied to the fourth subgroup in the reset period can be different from the lowermost voltages of signals supplied to the fourth subgroups in the intermediate period a by DV2.

In addition, in order to effectively compensate for the loss of the wall charges of the scan electrodes, the DV2 can be larger than the DV1.

As illustrated in FIG. 14, the scan bias voltage Vscb1 supplied to the first subgroup scan electrodes for a first scan period may be different from the scan bias voltage Vscb2_1 supplied to the second subgroup scan electrodes. Moreover, the scan bias voltage Vscb2_1, supplied to the second subgroup can electrodes for the first scan period in order to reduce loss of wall charges of the second subgroup scan electrodes that are generated for the first scan period, may be greater than the scan bias voltage Vscb1 supplied to the first subgroup scan electrodes.

Scan bias voltage Vscb3 supplied to third subgroup scan electrodes for a third scan period may be different from a scan bias voltage Vscb4_1 supplied to the fourth subgroup scan electrodes. Moreover, the scan bias voltage Vscb4_1, supplied to the fourth subgroup can electrodes for the third scan period in order to reduce loss of wall charges of the fourth subgroup scan electrodes that are generated for the third scan period, may be greater than the scan bias voltage Vscb3 supplied to the third subgroup scan electrodes.

In order to effectively reduce the loss of wall charged generated on the scan electrodes, Vscb4_1 may be greater than Vscb2_1.

However, in order to easily form and control the driving circuits, magnitudes of Vscb1, Vscb2_2, Vscb3, and Vscb4_2 may be identical to each other, and magnitudes of Vscb2_1 and Vscb4_1 may be identical to each other.

As described above, the high scan bias voltages Vscb2_1 and Vscb4_1 are preferably lower than the sustain voltage Vs. When the scan bias voltages Sccb2_1 and Vscb4_1 are lower than the sustain voltage Vs, it is possible to prevent power consumption from unnecessarily increasing and to reduce the generation of brilliant spot erroneous discharge as the amount of the wall charges of the scan electrodes is too large.

Different from as shown in FIG. 14, a scan bias voltage as high as Vscb4_1 may be supplied to the fourth subgroup scan electrode for the first and second scan periods, and gradually reducing signals may be supplied to the first group scan electrodes Y1 for an intermediate period (a).

The first group may include scan electrodes, of which the plural scan electrode which are positioned above the center of the panel, and the second group may include scan electrode which are positioned in the lower side.

Moreover, the first and second subgroups may include even and odd scan electrodes of the first group and the third and fourth subgroups may even and odd scan electrodes of the scan electrodes contained in the second group.

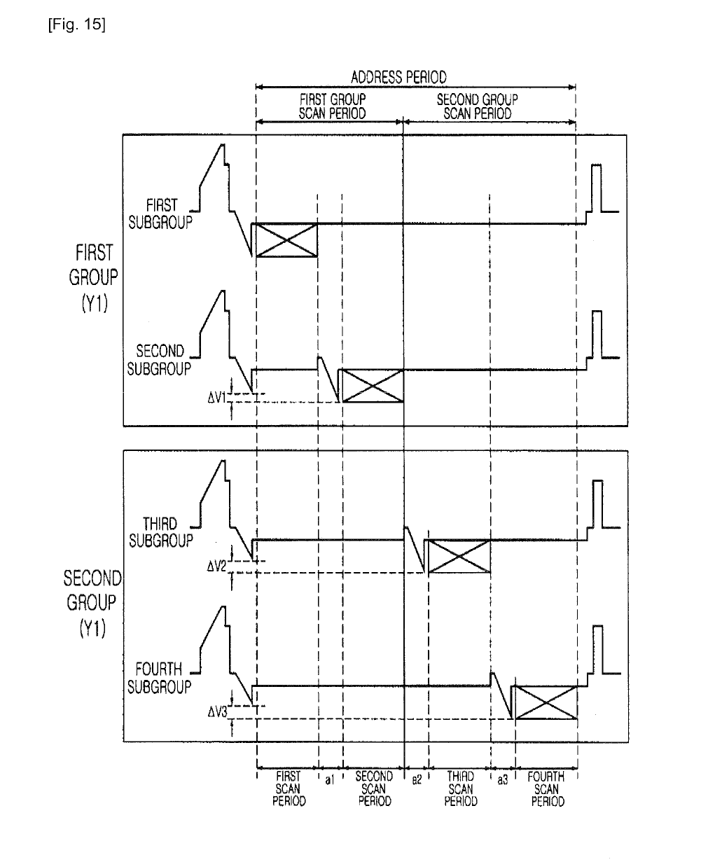

Referring to FIG. 15, gradually decreasing signals may be supplied to the second subgroup scan electrode for a first intermediate period (a1) between the scan periods of the first and second subgroups, gradually decreasing signals may be supplied to the third subgroup scan electrodes for a second intermediate period (a2) between the scan periods of the second and third subgroups, and gradually decreasing signal may be supplied to the fourth subgroup scan electrodes for a third intermediate period (a3) between scan periods of the third and fourth subgroups.

In this case, the lowermost voltages of set down signals supplied to the scan electrodes of the second, third, and fourth subgroups for a reset period in order to compensate for the loss of the wall charges of the scan electrodes may be higher than the lowermost voltages of signals supplied to the scan electrodes of the second, third, and fourth subgroups for the intermediate periods a1, a2, and a3.

However, in view of considering formation of a driving circuit and easy control of the driving circuit, the lowermost voltages of the signals supplied to the second third, and fourth subgroup scan electrodes for the intermediate periods a1, a2, and a3 may be identical to the lowermost voltages of the set down signals supplied to the first subgroup scan electrodes for the reset period. By doing so, there may be a difference as much as ΔV1 between the lowermost voltages of the set down signals supplied to the second subgroup for the reset period and the lowermost voltages of the signals supplied to the second subgroup for the first intermediate period a1, there may be a difference as much as ΔV2 between the lowermost voltages of the set down signals supplied to the second subgroup for the reset period and the lowermost voltages of the signals supplied to the second subgroup for the second intermediate period a2, and there may be a difference as much as ΔV3 between the lowermost voltages of the set down signals supplied to the bur subgroup for the reset period and the lowermost voltages of the signals supplied to the fourth subgroup for the third intermediate period a3.

Moreover, in order to more effectively compensate the loss of wall charges of the scan electrodes, the differences between the lowermost voltages may increase in the order of ΔV1, ΔV2, and ΔV3.

Different from as shown in FIG. 15, for the formation of a driving circuit and easy control of the driving circuit, gradually decreasing signals may be supplied to overall scan electrodes Y1 for the first, second, and third intermediate periods a1, a2, and a3.

The first group may include scan electrodes, of which the plural scan electrode which are positioned above the center of the panel, and the second group may include scan electrode which are positioned in the lower side.

Moreover, the first and second subgroups may include upper and lower scan electrodes of the first group and the third and fourth subgroups may upper and lower scan electrodes of the scan electrodes contained in the second group.

The driving signal shapes as described with reference to FIGS. 10 and 11 may be applied to some of subfields of the plural subfields for fanning a single frame, for example, at least one subfield of the subfields after the second subfield.

The driving signal shapes as shown in FIGS. 12 to 15 may be simultaneously applied to any one of the plural subfields, and if necessary, the driving signal shapes as shown in FIGS. 6 to 11 may be applied together. For example, the set down signals of the reset period in FIGS. 12 to 15 may include discontinuous descending period, and the lowermost voltages of the set down signals may be higher than the lowermost voltages of the scan signals.

In a case of a panel having a high resolution such as a Full HD, distances between the electrodes becomes narrow, the possibility of the erroneous discharge caused by an interactive between the electrodes such as the cross talk may increase.

By the scan electrode division driving method according to the present invention as described above, the interactive such as the cross talk between the electrodes of the panel with a high resolution such as a Full HD can be reduced and a great deal of electrode lines can be effectively driven.

Moreover, in a panel with a high resolution such as a Full HD, power consumption for driving the panel may be significantly increased, and widths of the scan signals are reduced to secure the driving margin of the panel so that the address discharge may be unstable. In a case of driving the panel with a high resolution such as a Full HD by the scan electrode division driving method according to an embodiment of the present invention, as described above, the possibility of an address erroneous discharge may be more increased.

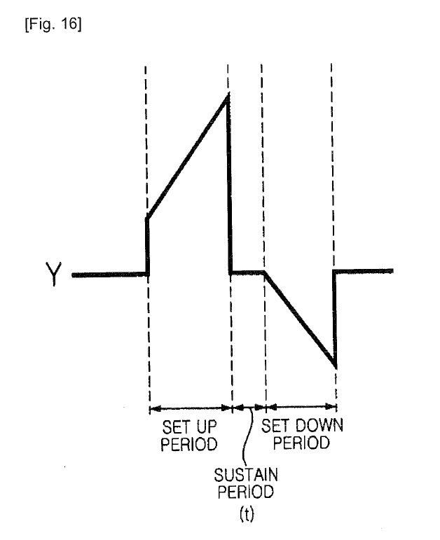

FIG. 16 is a timing diagram illustrating reset signal shapes supplied to the scan electrodes according to an embodiment of the present invention.

Referring to FIG. 16, the reset signal supplied to the scan electrodes Y for the reset period may include a setup period where a voltage is gradually increased, a sustain period where a predetermined voltage is maintained, and a set down period where the voltage is gradually reduced.

According to a plasma display device of the present invention, duration t of the sustain period of the reset signal may be varied.

During the setup period, negative (−) wall charges are generated on the scan electrodes Y for the address discharge by the gradually increasing voltage, and simultaneously space charges may be generated in the discharge cells. As described above, due to the interaction between the space charges and the wall charges which are generated far the setup period, the address discharge may be so unstable that the erroneous address discharge may be generated, and the possibility of the erroneous address discharge may be higher in high temperature circumstance or in a panel with a high resolution panel.

The space charges may be lost during the sustain period of the reset signal, and due to this, when the duration t of the sustain period of the reset signal increases, the quantity of the space charges to be lost increases so that the erroneous address discharge may be reduced.

Therefore, in a case of the plasma display device according to the present invention, the address discharge may be stable by adjusting the duration t of the sustain period of the reset signal. For example, in a case of an image signal with high possibility of the erroneous address discharge, the duration t of the sustain period of the reset signal itself increases or the duration t of the sustain period of the reset signal increases as temperature of the plasma display device increase so that the address discharge may be stable.

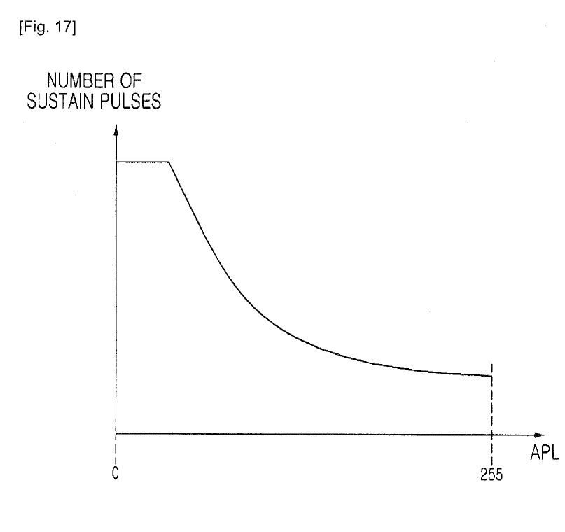

FIG. 17 is a graph illustrating a change in the number of sustain signals in accordance with the average picture level of image signals according to an embodiment of the present invention.

The average picture level (APL) of the image signals means an average load for displaying respective frames, for example, has 0 (zero) the lowermost APL in a case of a full black frame, and has 255 the highest APL in a case of a full white frame.

When the number of overall sustain signals that are supplied to the panel in order to display a single frame is fixed, electric power consumed for the driving of the panel may suddenly increase as the APL of the image signals increases.

Moreover, the APL may be defined by an average gray level in a single frame. In this case, the APL may be estimated by a value which summation of the number of grays of entire discharge cells is divided by the number of entire discharge cells.

Therefore, as shown in FIG. 17, the number of entire sustain signals supplied from a single frame is set to be reversely proportioned to the APL so that the power consumed to drive the panel can be maintained at a predetermined level.

when the APL increases due to this, the number of the sustain signals is reduced so that the sustain discharge may be concentrated to a front region of the periods for driving a single frame.

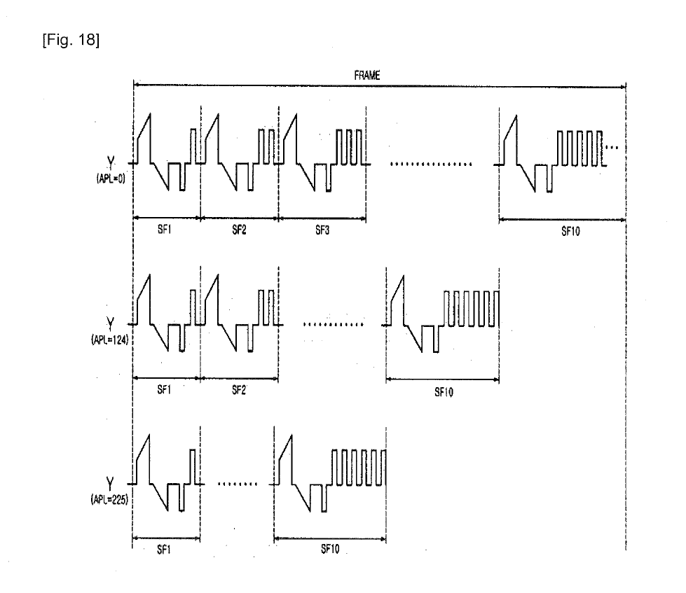

Referring to FIG. 18, when a single frame has ten subfields, a time point when a final subfield is ended may be pulled ahead as the APL increases. In other words, in a case of a frame in which the APL is 124, the time point where the final subfield is ended may be pulled ahead of the full black (APL=0) frame, and in a case of the full white (APL=255) frame, the time point when the final subfield is ended may be pulled ahead of a frame in which the APL is 124 and the full black (APL=0) frame.

By doing so, in the case of a full white (APL=255), the center of the sustain discharges generated within the frame is positioned in front of entire frames so that the quality of a displayed image is deteriorated.

Therefore, the duration t of the sustain period of the reset signal increases as the APL of the image signals increases so that the address discharge becomes stable and at the same time the center of the sustain discharges that are generated in the frame can be compensated to be near to the center of the frame.

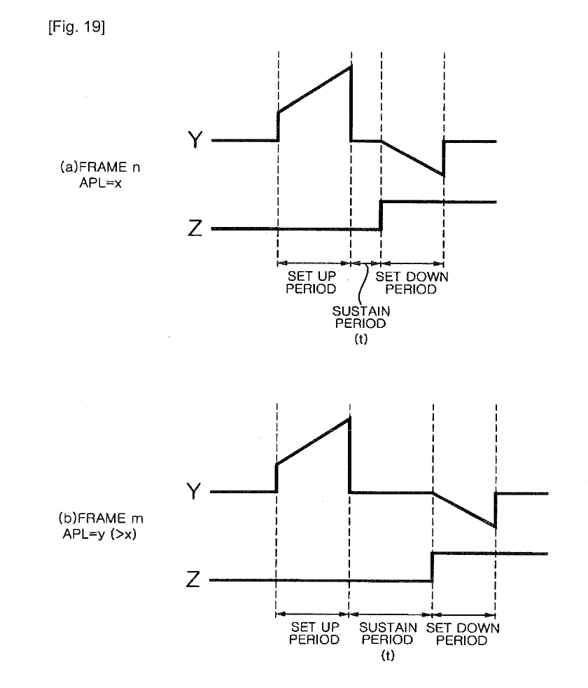

FIG. 19 is a timing diagram illustrating driving signal shapes according to a first embodiment of the present invention.

Referring to FIG. 19, a duration t2 of the sustain period of the reset signal supplied from a frame m (APL=y) may be greater than the duration t1 of the sustain period of the reset signal supplied from a frame n (APL=x) with an APL lower than that of the frame m.

The deterioration of the quality of the displayed image caused by the erroneous address discharge may be increased as the APL of the frame is high, and the problem of the deterioration of the quality of image may be serious in a high resolution panel.

As described above, the duration of the sustain period of the reset signal supplied from a frame with a high APL is increased so that the address discharge becomes stable and the quality of the displayed image can be improved, and so that a time point when the sustain discharges are generated are pushed back and the sustain discharges can be uniformly generated in the frame.

Moreover, as shown in FIG. 19, a time point when a bias voltage supplied to the sustain electrode Z may be varied according to the duration of the sustain period of the reset signal.

For example, the bias voltage may start to be supplied to the sustain electrode Z at the time point when the sustain period of the reset signal is ended. In other words, the bias voltage may start to be supplied to the sustain electrode Z at the same time of starting the set down period of the reset signal.

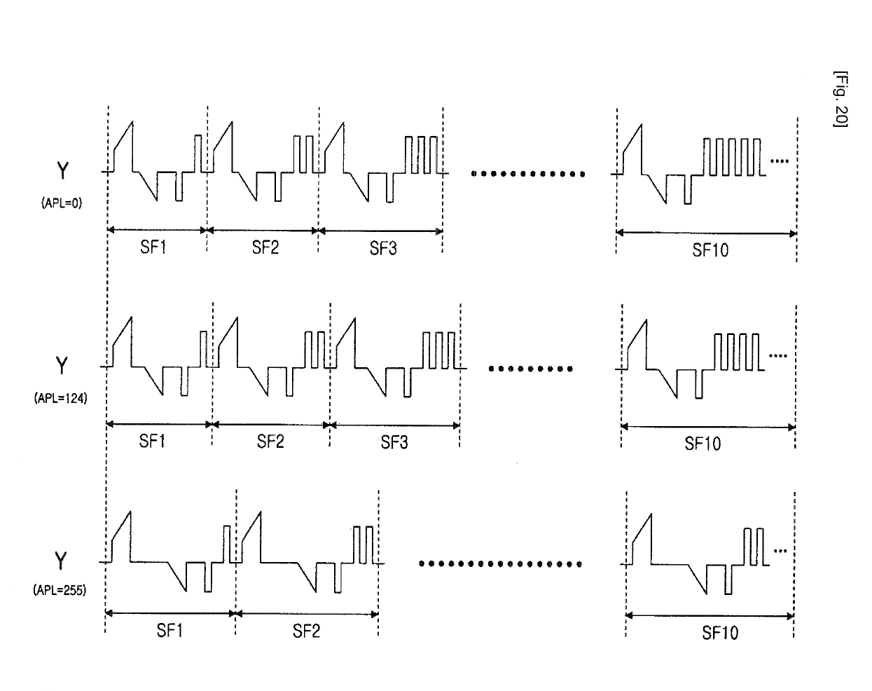

FIG. 20 is a timing diagram illustrating driving signal shapes according to a second embodiment of the present invention.

Referring to FIG. 20, the duration of the sustain period of the reset signal is increased as the APL of the frame increase so that the sustain discharges can be uniformly generated in the frame.

In other words, the duration of the sustain period of the reset signal supplied from a frame with APL of 124 is elongated than that of the full black (APL=0) frame so that a time point when a final subfield SF10 is ended in the two frames can be similarly adjusted.

Moreover, the duration of the sustain period of the reset signal supplied from the full white (APL=255) frame is elongated than that of the full black (APL=0) frame or the frame with APL of 124 so that the time point when the final subfield SF10 is ended in the three frames can be similarly adjusted.

As described above, the duration of the sustain period of the reset signal is increased as the APL of the frame increases so that the time point when the sustain discharges are generated can be delayed then the center of the sustain discharges can be near to the center of the frames.

Different from as shown in FIG. 20, as the APL of the frame increases, the duration of the sustain period of the reset signal supplied from some of the plural subfields that belong to the frame may increase.

When the duration of the sustain period of the reset signal increases in the rear subfields in which the number of sustain signals is great among the subfields for farming a single frame, the deterioration of the quality of the displayed image caused by the erroneous address discharge can be more effectively reduced.

For example, durations of reset signals supplied from seventh to ninth subfields of the plural subfields far forming a single frame can be set to be greater than durations of sustain periods of reset signals supplied from the rest of the subfields.

Moreover, as shown in FIG. 20, the durations of the sustain periods of the reset signals are preferably set such that the ending times of the final subfields are maintained to be similar to each other even when the APL of the frame may vary. However, the durations of the sustain periods of the reset signals may be set to be different from as shown in FIG. 20 by considering the stability of the address discharge or the power consumption.

The following table 1 lists results of measuring whether the erroneous address discharge is generated or not according to the variation of the durations of the sustain periods of the reset signals supplied from the full white frame when the duration of the sustain period of a reset signal supplied from the full black frame is 35 μs.

TABLE 1

| Duration of sustain | Duration of sustain | Whether erroneous address |
|---|---|---|
| period of Full black | period of Full white | discharge is generated |
| 35 μs | 180 μs | ◯ |
| 35 μs | 190 μs | ◯ |
| 35 μs | 200 μs | ◯ |
| 35 μs | 210 μs | X |
| 35 μs | 220 μs | X |
| 35 μs | 230 μs | X |
| 35 μs | 240 μs | X |
| 35 μs | 250 μs | X |
| 35 μs | 260 μs | X |
| 35 μs | 270 μs | X |
| 35 μs | 280 μs | X |
| 35 μs | 290 μs | X |
| 35 μs | 300 μs | X |
| 35 μs | 310 μs | X |
| 35 μs | 320 μs | X |
| 35 μs | 330 μs | X |
| 35 μs | 340 μs | X |
| 35 μs | 350 μs | X |
| 35 μs | 360 μs | ◯ |
| 35 μs | 370 μs | ◯ |
| 35 μs | 380 μs | ◯ |
| 35 μs | 390 μs | ◯ |
| 35 μs | 400 μs | ◯ |

Referring to table 1, when the duration of the sustain period of the reset signal supplied from the full white frame is longer than 210 μs, the space charges are sufficiently lost for the sustain period so that the erroneous address discharge is prevented.

However, when the duration of the sustain period of the reset signal supplied from the full white frame significantly increases greater than 360 μs, the wall charges generated on the scan electrodes Y during the sustain period so that the address discharge is unstable.

Therefore, when the duration of the sustain period of the reset signal supplied from the full white frame is 210 μs to 350 μs, that is, when the duration of the sustain period of the reset signal supplied fro the full white frame is six to ten times the duration of the sustain period of the reset signal supplied from the full black frame, the sustain discharges can be uniformly contributed within the frame and the erroneous address discharge can be prevented.

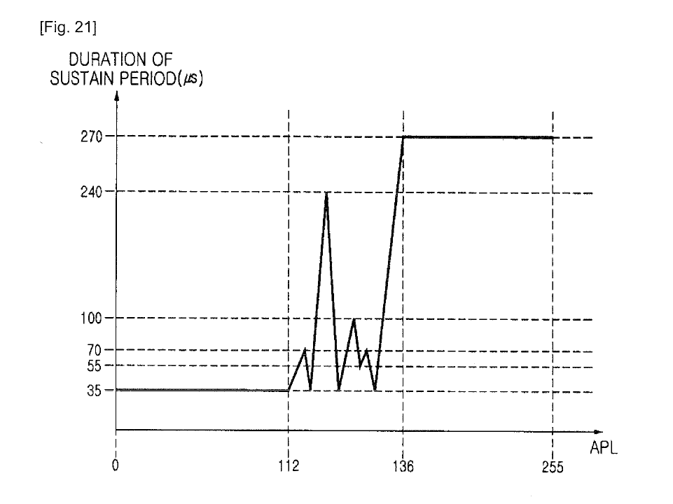

The following table 2 represents an embodiment where a variable duration of the sustain period of the reset signal is set according to the APL of the image signal and FIG. 21 is a graph illustrating the setting values.

TABLE 2

| APL | Duration of sustain period |
|---|---|
| 0~112 | 35 μs |
| 113 | 46 μs |
| 114~116 | 70 μs |
| 117 | 35 μs |
| 118 | 60 μs |
| 119~120 | 100 μs |
| 121 | 170 μs |
| 122 | 210 μs |
| 123 | 240 μs |
| 124 | 70 μs |
| 125 | 35 μs |
| 125 | 60 μs |
| 127 | 100 μs |
| 128 | 55 μs |
| 129 | 70 μs |
| 130 | 36 μs |
| 131 | 100 μs |
| 132 | 140 μs |
| 133~134 | 170 μs |
| 135 | 210 μs |
| 136~255 | 270 μs |

As shown in table 2 and FIG. 21, the APL with 0 (zero) to 255 may be divided into a plurality of periods and the duration of the sustain period of the reset signal may increase or be reduced in the respective plural periods.

The periodic division of the APL and the duration of the sustain period of the reset signal in the divided respective periods may be different according to subfield mapping methods.

According to the plasma display device of the present invention, when the plurality of scan electrodes formed in the plasma display panel are divided into two or more groups to be driven, a voltage sustain period of the reset signal is adjusted according to the average picture level of the image signals so that the discharges can be uniformly generated in the frame and the address discharges can be stable.

Moreover, the method of driving a plasma display panel according to the present invention can be implemented by codes readable by a computer on a computer readable recording medium. The computer readable medium includes whole recording medium on which data read by a computer system are stored. For example of the computer readable medium, there are ROM, RAM, CD-ROM, magnetic tape, floppy disc, optical data storage, and the like, and a recording medium implanted by a carrier wave (for example, transmission through internet). Moreover, the computer readable medium may be distributed to computer system interconnected to each other by a network such that computer readable codes are stored and executed by computers. Functional programs, codes, and code segments for implementing the present invention can be easily induced by programmers in this art of the present invention.

The invention being thus described, it will be obvious that the same may be varied in many ways. Such variations are not to be regarded as a departure from the spirit and scope of the invention, and all such modifications as would be obvious to one skilled in the art are intended to be comprised within the scope of the following claims.

1. A plasma display device, comprising:
a plasma display panel (PDP) including a plurality of scan electrodes and sustain electrodes formed on an upper substrate and a plurality of address electrodes formed on a lower substrate; and
drivers for supplying driving signals to the plurality of electrodes,
wherein reset signals supplied to the scan electrodes in a reset period sequentially comprise a set up period gradually rising to a first voltage, a sustain period sustaining a second voltage, and a set down period gradually falling from the second voltage,
wherein a duration of the sustain period varies in accordance with an average picture level (APL) of an image signal,
wherein the plurality of scan electrodes are divided into first and second groups,
wherein an address period comprises first and second group scan periods for supplying scan signals to the first and second groups, respectively, and
wherein scan bias voltages supplied to the first and second groups in at least one period of the first and second group scan periods are different from each other.

2. The plasma display device as claimed in claim 1, wherein the number of sustain signals supplied in one frame is in inverse proportion to the APL of the frame.

3. The plasma display device as claimed in claim 2, wherein, when the number of sustain signals supplied in the one frame is reduced, the duration of the sustain period increases.

4. The plasma display device as claimed in claim 2, wherein, when a center of light generated by one frame is ahead of a center of a period for driving the frame, the duration of the sustain period is increased.

5. The plasma display device as claimed in claim 1, wherein the duration of the sustain period is in proportion to the APL.

6. The plasma display device as claimed in claim 1, wherein, when the APL is divided into a plurality of periods, the duration of the sustain period is in proportion to the APL in a first period among the plurality of periods and the duration of the sustain period is in inverse proportion to the APL in a second period.

7. The plasma display device as claimed in claim 1, wherein a first duration that is the duration of the sustain period of reset signals supplied in an nth subfield of a full white frame is larger than a second duration that is the duration of the sustain period of reset signals supplied in the nth subfield of a full black frame.

8. The plasma display device as claimed in claim 7, wherein the first duration is 210 μs to 350 μs.

9. The plasma display device as claimed in claim 7, wherein the first duration is 6 to 10 times the second duration.

10. The plasma display device as claimed in claim 7, wherein the nth subfield is one of seventh to ninth subfields.

11. The plasma display device as claimed in claim 1, wherein, when the APL is divided into a plurality of periods, the duration of the sustain period is in proportion to the APL in a first period among the plurality of periods and the duration of the sustain period is in inverse proportion to the APL in a second period.

12. The plasma display device as claimed in claim 1, wherein the duration of the sustain period varies in a range of 30 μs to 300 μs.

13. The plasma display device as claimed in claim 1,
wherein a bias voltage is supplied to the sustain electrodes in at least a partial period of the reset period, and
wherein a supply start point of time of the bias voltage varies in accordance with the duration of the sustain period.

14. The plasma display device as claimed in claim 13, wherein the supply start point of time of the bias voltage is actually the same as a start point of time of the set down period.

15. The plasma display device as claimed in claim 1,
wherein the address period sequentially comprises first and second group scan periods in which scan signals are supplied to the first and second groups, respectively, and
wherein a scan bias voltage supplied to the second group is larger than a scan bias voltage supplied to the first group in the first group scan period.

16. The plasma display device as claimed in claim 1,
wherein the address period comprises first and second group scan periods in which scan signals are supplied to the first and second groups, respectively, and
wherein gradually falling set down signals are applied to at least one of the first and second groups in a period between the first and second group scan periods.

17. The plasma display device as claimed in claim 16, wherein the lowermost voltages of reset signals supplied to the second group in the reset period are higher than lowermost voltages of set down signals supplied to the second group in a period between the first and second group scan periods.

18. The plasma display device as claimed in claim 16, wherein lowermost voltages of reset signals supplied to the first group are lower than lowermost voltages of the reset signals supplied to the second group.

19. The plasma display device as claimed in claim 1, wherein lower most voltages of reset signals supplied to at least one of the first and second groups are higher than a negative polar scan voltage.

20. The plasma display device as claimed in claim 1, wherein discontinuous set down signals sequentially comprising a first falling period gradually falling to a first voltage, a sustain period sustaining the first voltage, and a second falling period gradually falling from the first voltage are supplied to at least one of the first and second groups in the reset period.
